(19) United States
(12) Patent Application Publication
(10) Pub. No.: US 2012/0117880 A1
(43) Pub. Date: May 17, 2012

(54) SLIDING WINDOW ASSEMBLY FOR A VEHICLE

(75) Inventors: David W. Lahnala, Adrian, MI (US); Mark S. Ackerman, Brooklyn, MI (US)

(73) Assignee: AGC AUTOMOTIVE AMERICAS CO., Alpharetta, GA (US)

(21) Appl. No.: 13/015,902

(22) Filed: Jan. 28, 2011

Related U.S. Application Data
(63) Continuation-in-part of application No. 12/944,448, filed on Nov. 11, 2010.

(51) Int. Cl. B60J 1/00; B60L 1/02

(52) U.S. Cl. 49/70; 219/203

(57) ABSTRACT

The present invention provides a sliding window assembly for a vehicle including a fixed panel and a first heating grid coupled to the fixed panel. A sliding panel is movably coupled to a track and a second heating grid is coupled to the sliding panel. A conductive rail is coupled to the track and includes a first conductive segment, a second conductive segment spaced from the first conductive segment, and an insulator segment disposed between the first and second conductive segments with the first and second heating grids remaining electrically connected to the first and second conductive segments in both the open and closed positions in a series circuit. In one configuration, a sliding window assembly includes a connector disposed between a heating grid and a conductive rail with the connector comprising a compressible material and having a conductive property to define a conductive connector.

### CROSS REFERENCE TO RELATED APPLICATION

This application is a continuation-in-part of co-pending U.S. Non-Provisional patent application Ser. No. 12/944,448 filed on Nov. 11, 2010, the disclosure of which are hereby incorporated by reference in its entirety.

### BACKGROUND OF THE INVENTION

1. Field of the Invention

The present invention generally relates to a sliding window assembly for a vehicle.

2. Description of the Related Art

Window assemblies for vehicles are known in the art. One type of window assembly includes a first panel and a second panel each fixed to the vehicle. The first and second panels are spaced from each other to define an opening therebetween. A sliding panel is disposed between the first and second panels and is movable relative to the first and second panels between an open position and a closed position to selectively cover the opening.

The first, second, and sliding panels typically each include a heating grid for defrosting the respective panels. Further, the heating grids of the first, second, and sliding panels are electrically connected to the power source in a series circuit. In other words, electrical current flows through the heating grid of the first panel, then through the heating grid of the sliding panel, and finally through the heating grid of the second panel. Therefore, if the circuit is broken at the heating grid of the first panel, electrical current will not flow to the heating grids of the sliding panel and the second panel. For example, when the first, second, and sliding panel are electrically connected in series, and when the sliding panel moves from the closed position to the open position, the circuit is broken between the sliding panel and the second panel. As such, when the sliding panel is in the open position, electrical current will not flow through the heating grids of the sliding panel and the second panel, thus the sliding panel and the second panel will fog up or frost over which can create unsafe driving conditions. Alternatively, an occupant of the vehicle has to keep the sliding panel in the closed position to operate all of the heating grids to defrost all of the panels, which can lead to temperature or other discomforts within the vehicle cabin.

In addition, a plurality of connections are soldered to each of the heating grids to provide electrical current to the heating grids. Each of the connections typically include wires extending therefrom. Soldering connections to the heating grids is time consuming. Further, if the solder fails, then the connection where the solder fails becomes detached from the respective heating grid and thus prevents electrical current from flowing to the heating grid.

Therefore, there remains an opportunity to develop a sliding window assembly.

### SUMMARY OF THE INVENTION

The present invention provides a sliding window assembly for a vehicle including a fixed panel adapted to be fixed to the vehicle and a first heating grid coupled to the fixed panel for defrosting the fixed panel. The assembly further includes a track coupled to the fixed panel and a sliding panel movably coupled to the track such that the sliding panel moves relative to the fixed panel between an open position and a closed position. The assembly also includes a second heating grid coupled to the sliding panel for defrosting the sliding panel with the first and second heating grids electrically connected in a series circuit and a conductive rail coupled to the track. The conductive rail includes a first conductive segment, a second conductive segment spaced from the first conductive segment, and an insulator segment disposed between the first and second conductive segments with the first and second heating grids remaining electrically connected to the first and second conductive segments in both the open and closed positions in the series circuit.

The present invention also provides a sliding window assembly for a vehicle including a panel adapted to be coupled to the vehicle and a heating grid coupled to the panel for defrosting the panel. The assembly further includes a conductive rail coupled to the panel for electrifying the heating grid. The assembly also includes a connector disposed between the heating grid and the conductive rail with the connector comprising a compressible material and having a conductive property to define a conductive connector for electrically connecting the heating grid to the conductive rail.

Therefore, the sliding window assembly of the present invention enables the first and second heating grids to remain electrically connected to remain electrically connected to the first and second conductive segments in both the open and closed positions in the series circuit. Hence, the fixed and sliding panels can be defogged or defrosted when the sliding panel is in both the open and closed positions; thus providing an occupant of the vehicle with safer driving conditions, as well as a more comfortable vehicle cabin. In addition, the connector having the conductive property provides electrical connection from the conductive rail to the heating grid; thus reducing the number of connectors to electrically connect the heating grids as compared to the soldered connections discussed in the background of the invention. Eliminating soldered connections reduces the number of wires to be hidden, as well as reduces assembly time and the possibility of the solder failing. Further, the connector comprising the compressible material is able to take up space between the conductive rail and the panel due to manufacturing tolerances, as well as prevent breakage of the panel during assembly of the conductive rail and the panel.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 is a perspective view of a sliding window assembly installed on a vehicle with a sliding panel in a closed position.

FIG. 2 is a perspective view of an interior of a sliding window assembly having a fixed panel and a sliding panel in a closed position.

FIG. 3A is a cross-sectional view of a connector disposed between a conductive rail and a heating grid prior to being compressed with an adhesive layer abutting the conductive rail.

FIG. 3B is a cross-sectional view of the connector disposed between the conductive rail and the heating grid after being compressed with the adhesive layer abutting the conductive rail.

FIG. 4A is a cross-sectional view of the connector disposed between the conductive rail and the heating grid prior to being compressed with a first adhesive layer abutting the conductive rail and a second adhesive layer abutting the heating grid.

FIG. 4B is a cross-sectional view of the connector disposed between the conductive rail and the heating grid after being compressed with the first adhesive layer abutting the conductive rail and the second adhesive layer abutting the heating grid.

FIG. 5 is an exploded perspective view of the connector.

FIG. 6 is a perspective view of an exterior of another sliding window assembly having a first fixed panel and a second fixed panel spaced from each other with the sliding panel in an open position.

FIG. 7 is a plan view of the sliding window assembly with a conductive rail coupled to a first track and the sliding panel in a closed position.

FIG. 8 is a perspective view of the sliding window assembly including a latch to move the sliding panel between the open and closed positions.

FIG. 9 is a perspective view of the sliding window assembly including a cable-motor power system to move the sliding panel between the open and closed positions.

FIG. 10 is an exploded perspective view of the first and second fixed panels, the sliding panel, a first conductive segment, a second conductive segment, an insulator segment, a first connector, a second connector, a first slide connector and a second slide connector of the configuration in which the conductive rail is coupled to the first track.

FIG. 11 is a broken perspective view of the first and second fixed panels and the sliding panel, the first and second conductive segments, and the insulator segment of the configuration in which the conductive rail is coupled to the first track with the first slide connector engaging the first conductive segment and the second slide connector engaging the second conductive segment.

FIG. 12 is a cross-sectional view of the first track, the insulator segment, the sliding panel, and a bracket.

FIG. 13 is a cross-sectional view of the track, the second conductive segment, the second slide connector, a third flange and a fourth flange of the insulator segment, the bracket, and the sliding panel of the configuration in which the conductive rail is coupled to the first track.

FIG. 14 is a plan view of an interior of yet another sliding window assembly with a conductive rail coupled to a second track.

FIG. 15 is a perspective view of the sliding window assembly with the conductive rail coupled to the second track.

FIG. 16 is an exploded perspective view of the first and second fixed panels, the sliding panel, the first and second conductive segments, the insulator segment, the first and second connectors, and the first and second slide connectors of the configuration in which the conductive rail is coupled to the second track.

FIG. 17 is a cross-sectional view of the second conductive segment, the second slide connector, and the sliding panel taken from lines 17-17 of FIG. 15.

FIG. 18 is a plan view of a first terminal connector disposed on a first heating grid.

FIG. 19 is an exploded perspective view of an interior of another sliding window assembly including a first conductive connector, a second conductive connector, a third conductive connector, a first conductive rail, and a second conductive rail disposed above the first conductive rail.

FIG. 20 is an exploded perspective view of an interior of yet another sliding window assembly including a first conductive connector, a second conductive connector, a third conductive connector, and a fourth conductive connector, a first conductive rail and a second conductive rail disposed above the first conductive rail.

### DETAILED DESCRIPTION OF THE INVENTION

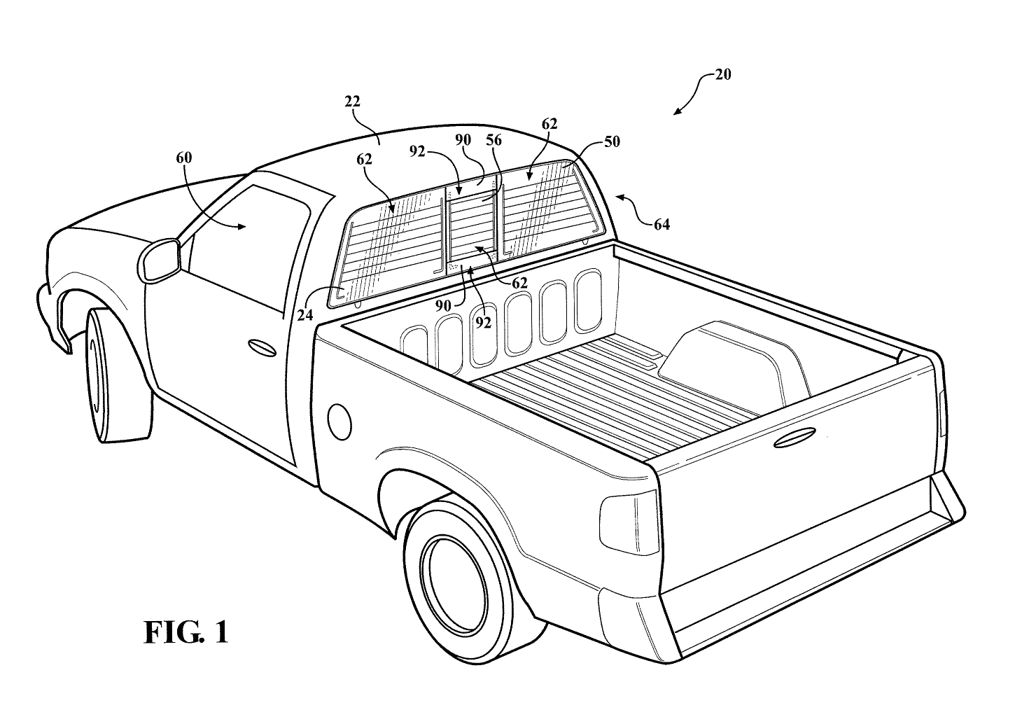

Referring to the Figures, wherein like numerals indicate like or corresponding parts throughout the several views, a sliding window assembly 20 for a vehicle 22 is generally shown. Typically, as shown in FIG. 1, the sliding window assembly 20 is coupled to a rear window body of a pickup truck 22. However, it is to be appreciated that the sliding window assembly 20 can be coupled to any suitable location of other types of vehicles 22 or non-vehicles.

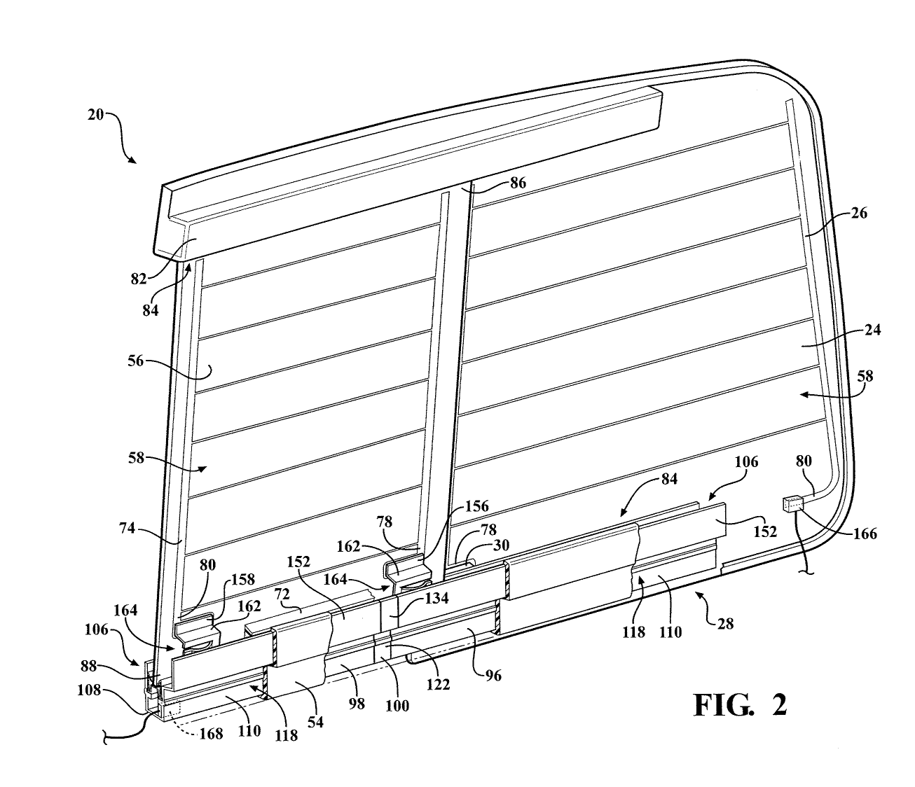

Referring to FIG. 2, the sliding window assembly 20 includes a panel 24 adapted to be coupled to the vehicle 22 and a heating grid 26 coupled to the panel 24 for defrosting the panel 24. The panel 24 can be a fixed panel 24, 50 and/or a sliding panel 56. Fixed 24, 50 and sliding panels 56 are discussed further below. The panel 24 is typically formed of glass. However, it is to be appreciated that the panel 24 can be formed of any suitable material(s) such as plastic, metal, etc. Various configurations of the panel 24 and the heating grid 26 are discussed further below.

The sliding window assembly 20 further includes a conductive rail 28 coupled to the panel 24 for electrifying the heating grid 26. The conductive rail 28 can be of any suitable configuration and examples of suitable configurations are discussed further below.

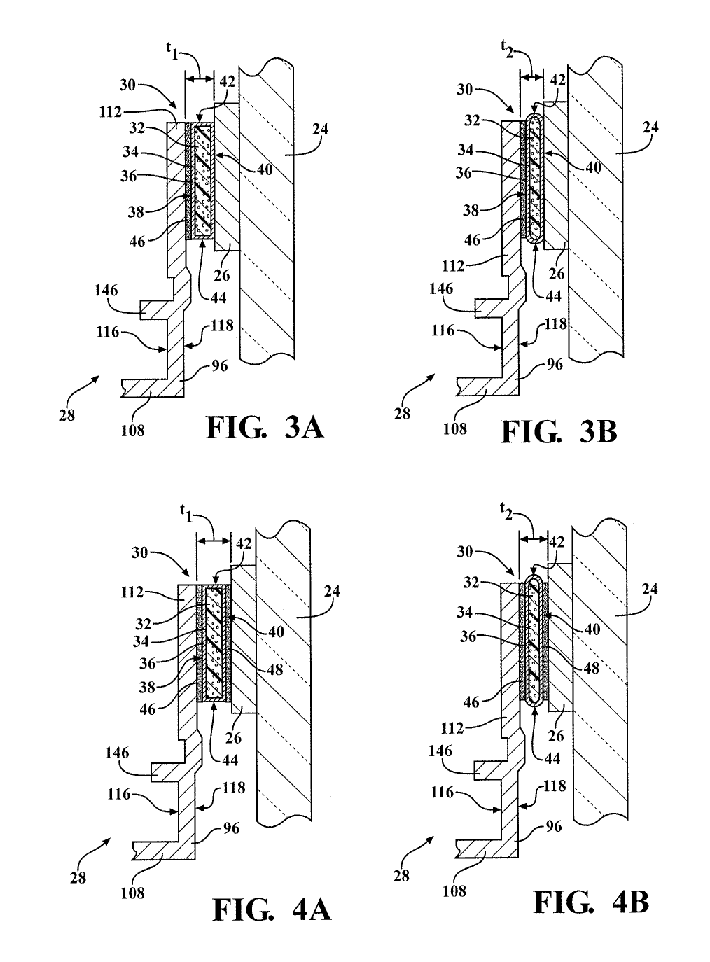

Turning to FIGS. 3A, 3B, 4A, and 4B, the sliding window assembly 20 also includes a connector 30 disposed between the heating grid 26 and the conductive rail 28. The connector 30 comprises a compressible material 32 and has a conductive property to define a conductive connector 30 for electrically connecting the heating grid 26 to the conductive rail 28. The connector 30 provides an electrical connection between the heating grid 26 and the conductive rail 28, and also prevents breakage of the panel 24 during assembly of the connector 30 between the heating grid 26 and the conductive rail 28. For this discussion, it is to be appreciated that the conductive connector 30 is also referred to as the connector 30.

The connector 30 defines a first thickness t₁ prior to being compressed between the heating grid 26 and the conductive rail 28 as shown in FIGS. 3A and 4A and a second thickness t₂ of about ½ to ⅔ less than the first thickness t₁ after being compressed between the heating grid 26 and the conductive rail 28 as shown in FIGS. 3B and 4B. The connector 30 is compressed to take up space between the conductive rail 28 and the heating grid 26 due to manufacturing tolerances of the conductive rail 28, the heating grid 26, and/or the panel 24. In addition, having the connector 30 compressible prevents breakage of the panel 24 during assembly of the connector 30 between the heating grid 26 and the conductive rail 28. For example, the first thickness t₁ of the connector 30 can be of from about 5.0 millimeters to 7.0 millimeters prior to being compressed between the heating grid 26 and the conductive rail 28 and the second thickness t₂ of the connector 30 can be of from about 1.5 millimeters to 3.5 millimeters after being compressed between the heating grid 26 and the conductive rail 28. In one embodiment, the second thickness t₂ of the connector 30 is about 2.5 millimeters. Further, in one embodiment, the first thickness t₁ of the connector 30 is about 6.7 millimeters. It is to be appreciated that the first thickness t₁ and the second thickness t₂ can be any suitable thickness, and the second thickness t₂ can be compressed less or more than described above. Further, it is to be appreciated that the compressible material 32 can rebound.

Typically, the compressible material 32 comprises a foam. More typically, the foam comprises a polymer, which is foamed or expanded. For example, the compressible material 32 can be an expanded or foamed polymer. In certain embodiments, the polymer is polyurethane, such that the compressible material 32 is polyurethane foam, e.g. a closed cell polyurethane foam. In other embodiments, the polymer is rubber and formed from ethylene propylene diene monomer (EPDM), such that the compressible material 32 is foamed EPDM. In yet other embodiments, the polymer is a conductive polymer. Conducive polymers can also be referred to in the art as intrinsically conductive polymers (ICPs), which are polymers that can conduct electrical current or electricity. The compressible material 32, and more specifically the foam has an outer periphery 34, which is discussed further below.

The connector 30 can further comprise a conductive filler dispersed in the compressible material 32 for electrically connecting the heating grid 26 to the conductive rail 28. In one embodiment, the conductive filler defines the conductive property. Therefore, in certain embodiments, the connector 30 is formed from the foam and the conductive filler. The conductive filler can be selected from various conductive fillers understood in the art, such as metal or carbon filler, which can be in various forms such as powder, fibers, etc. In certain embodiments, the conductive filler comprises metal, e.g. a metal powder.

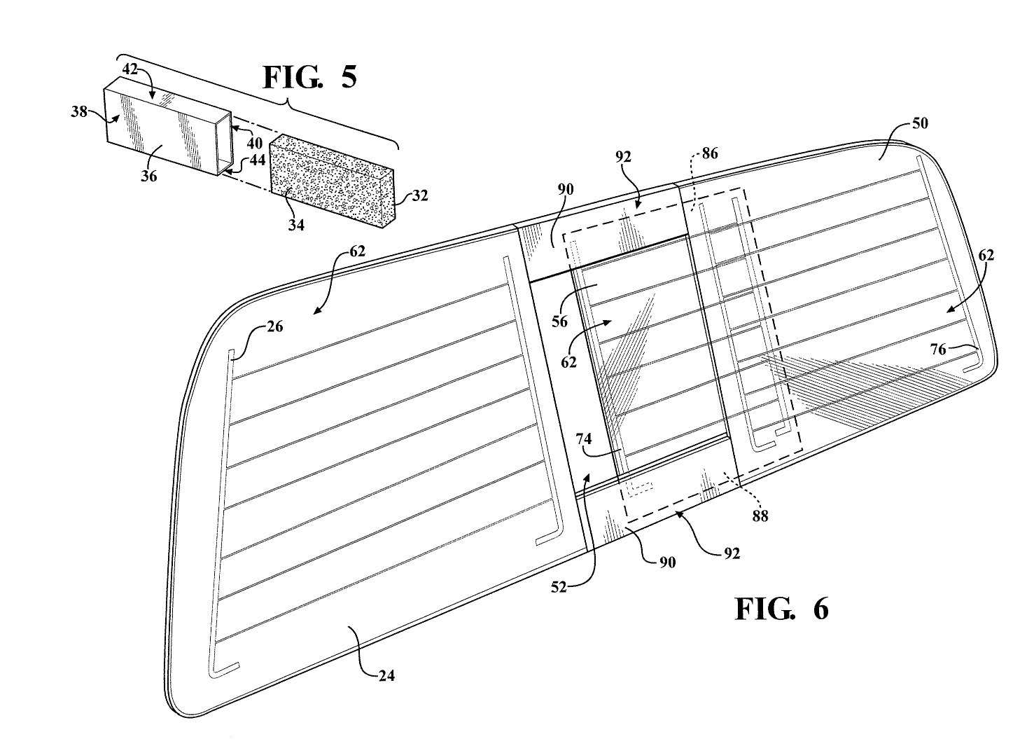

In one embodiment, also referring to FIG. 5, the connector 30 further comprises a foil layer 36 surrounding the foam. More specifically, the foil layer 36 surrounds the outer periphery 34 of the foam. In another embodiment, the foil layer 36 entirely surrounds the outer periphery 34 of the foam. In yet another embodiment, the foil layer 36 partially surrounds the outer periphery 34 of the foam. In certain embodiments, the foil layer defines the conductive property. Typically, the foil layer 36 comprises metal, more typically, the foil layer 36 comprises aluminum. In certain embodiments, the foil layer 36 comprises a fabric-reinforced metal, such as fabric-reinforced aluminum. It is to be appreciated that the foil layer 36 can be formed of any suitable material(s) for electrically connecting the heating grid 26 to the conductive rail 28. Further, it is to be appreciated that the foam, e.g. polyurethane foam, including the foil layer 36 can also include the conductive filler and/or be formed from the conductive polymer.

The foil layer 36 has a first surface 38 and a second surface 40 opposing the first surface 38. Typically, the first surface 38 faces the conductive rail 28 and the second surface 40 faces the heating grid 26. The foil layer 36 further has a third surface 42 and a fourth surface 44 opposing the third surface 42 with the third and fourth surfaces 42, 44 adjacent the first and second surfaces 38, 40 such that the first, second, third, and fourth surfaces 38, 40, 42, 44 define a generally rectangular configuration. It is to be appreciated that the first, second, third, and fourth surface 38, 40, 42, 44 can cooperate to define any suitable configuration, such as, for example, square, oval, etc.

The sliding window assembly 20 can comprise an adhesive layer 46 abutting at least one of the heating grid 26 and the conductive rail 28 for coupling the conductive connector 30 thereon. In certain embodiments, the connector 30 can further comprise the adhesive layer 46 abutting at least one of the heating grid 26 and the conductive rail 28 for coupling the conductive connector 30 thereon. In various embodiments, the adhesive layer 46 abuts at least one of the first and second surfaces 38, 40 of the foil layer 36 and at least one of the heating grid 26 and the conductive rail 28 for coupling the conductive connector 30 thereon. Referring to FIGS. 3A and 3B, the adhesive layer 46 abuts the first surface 38 of the foil layer 36. More specifically, the adhesive layer 46 abuts the first surface 38 of the foil layer 36 and the conductive rail 28. It is to be appreciated that the adhesive layer 46 can abut the second surface 40 of the foil layer 36 instead of, or in addition to, the first surface 38. Hence, the adhesive layer 46 can abut the second surface 40 of the foil layer 36 and the heating grid 26. The third and fourth surfaces 42, 44 of the foil layer 36 are typically free of the adhesive layer 46. However, it is to be appreciated that the adhesive layer 46 can abut at least a portion of the third and/or fourth surfaces 42, 44 of the foil layer 36.

Referring to FIGS. 4A and 4B, the adhesive layer 46 is further defined as a first adhesive layer 46 abutting the first surface 38 of the foil layer 36 and further including a second adhesive layer 48 abutting the second surface 40 of the foil layer 36. More specifically, the first adhesive layer 46 abuts the first surface 38 and the conductive rail 28 and the second adhesive layer 48 abuts the second surface 40 and the heating grid 26. The third and fourth surfaces 42, 44 of the foil layer 36 are typically free of the first and second adhesive layers 46, 48. However, it is to be appreciated that the first and/or second adhesive layers 46, 48 can abut at least a portion of the third and/or fourth surfaces 42, 44 of the foil layer 36. It is to be appreciated that the first and/or second adhesive layers 46, 48 can also orientate the connector 30 on the heating grid 26 and/or the conductive rail 28.

The adhesive layer 46, and more specifically the first and second adhesive layers 46, 48, typically comprises a pressure sensitive adhesive (PSA), such as acrylic. In certain embodiments, the adhesive layer 46 is formed from a conductive composition. More specifically, the first and/or second adhesive layers 46, 48 is/are formed from the conductive composition for electrically connecting the conductive rail 28 to the heating grid 26. In other embodiments, the adhesive layer 46, and more specifically the first and second adhesive layers 46, 48, comprise a conductive filler for electrically connecting the conductive rail 28 to the heating grid 26. The conductive filler of the adhesive layer 46 electrically connects the connector 30 to the conductive rail 28 and the heating grid 26. The conductive filler can be selected from various conductive fillers understood in the art, such as metal or carbon filler, which can be in various forms such as powder, fibers, etc. In various embodiments, the conductive filler of the first and/or second adhesive layers 46, 48 comprises conductive acrylic. It is to be appreciated that the first and/or second adhesive layers 46, 48 can be non-conductive. It is to further be appreciated that the first and/or second adhesive layers 46, 48 can be of any suitable material(s), including non-conductive material(s), for electrically connecting the conductive rail 28, the connector 30, and the heating grid 26 to each other and/or for coupling the conductive connector 30 to the conductive rail 28 and/or the heating grid 26.

The connector 30 typically has a compression-deflection of less than 12 psi, at 25% deflection, according to ASTM D3574 Modified; and/or a compression set of less than 20%, at 25% deflection, according to ASTM D395 Method B. In certain embodiments, the connector 30 has a compression-deflection of less than 4 psi, at 25% deflection, according to ASTM D3574 Modified; and a compression set of less than 20%, at 25% deflection, according to ASTM D395 Method B. Suitable connectors 30, for purposes of the present invention, are commonly available from Marian of Indianapolis, Ind. under the trade name Soft-Shield®. Specific examples include the Soft-Shield® 4000 Series, such as Soft-Shield® 4000, Soft-Shield® 4002, Soft-Shield® 4004, Soft-Shield® 4006, and Soft-Shield® 4008. In one embodiment, the connector 30 is formed from the Soft-Shield® 4002. It is to be appreciated that the actual values for the compression-deflection varies with the first thickness t₁ of the connector 30.

As described above, in certain embodiments the connector 30 is formed from a Soft-Shield® 4000 Series product, which are conventionally sold as gaskets. In certain embodiments, the connector 30 is manufactured by compressing one of the gaskets between the conductive rail 28 and the heating grid 26 as discussed above. Specific properties of this product series is described immediately below. For Soft-Shield® 4000, 4002, 4004, 4006, and 4008, compression cycling is 0.006 ohms (initial) and 0.032 ohms (final), at 10,000 cycles, at 50% deflection. For Soft-Shield® 4000, 4002, 4004, 4006, and 4008, surface resistivity after heat aging for 168 hours at 185° F. is 0.009 ohms/sq. in. (initial) and 0.014 ohms/sq. in. (final), after heat aging for 168 hours at 250° F. is 0.007 ohms/sq. in. (initial) and 0.017 ohms/sq. in. (final), after heat aging for 168 hours at 95% RH/95° F. is 0.007 ohms/sq. in. (initial) and 0.010 ohms/sq. in. (final), and after heat aging for 2190 hours at 158° F. is 0.010 ohms/sq. in. (initial) and 0.010 ohms/sq. in. (final), according to CHO-TM-TP57³. For Soft-Shield® 4000, 4002, 4004, 4006, and 4008, abrasion resistance (Taber Abrader) is 0.007 ohms/sq. in. (initial) and 0.010 ohms/sq. in. (final), at 500 cycles (500 g on CS wheel), according to ASTM D460. For Soft-Shield® 4000, 4002, 4004, 4006, and 4008, initial PSA adhesion is greater than 2.5 lb./in., according to ASTM D1000.

In one embodiment, the connector 30 is manufactured with the adhesive layer 46 adhered thereon. It is to be appreciated that the connector 30 can be manufactured without the adhesive layer 46 such that the adhesive layer 46 is later applied to the connector 30, the conductive rail 28, and/or the heating grid 26 prior to coupling together the connector 30, the conductive rail 28, and the panel 24. Further, it is to be appreciated that the adhesive layer 46 can be eliminated. In addition, it is to be appreciated that the connector 30 can be manufactured in long lengths, such as tape, and thus cut to any desired length. For example, the connector 30 can be cut into lengths of about 30.0 millimeters. It is to be appreciated that the connector 30 can be any suitable width, and as an example, the width can be of from about 11.0 to 13.5 millimeters. In one embodiment, the width is about 12.7 millimeters.

The connector 30, and more specifically the conductive connector 30, as discussed above, can be utilized with any of the embodiments discussed herein. Various examples of suitable locations for utilizing the conductive connector 30 with the conductive rail 28 and/or the heating grid 26 are discussed below.

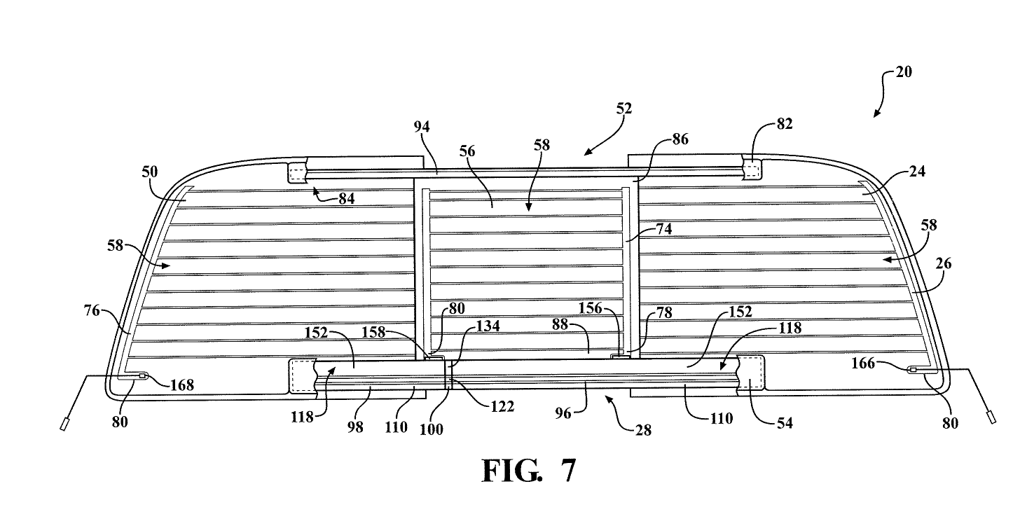

Referring back to FIG. 2, the sliding window assembly 20 includes a fixed panel 24 adapted to be fixed to the vehicle 22 and a first heating grid 26 or left heating grid 26 coupled to the fixed panel 24 for defrosting the fixed panel 24. In certain embodiments, as shown in FIGS. 1, 6-11, 14-16, 19, and 20, the fixed panel 24 is further defined as a first fixed panel 24 and further including a second fixed panel 24, 50 adapted to be fixed to the vehicle 22. As best shown in FIGS. 6 and 7, the first and second fixed panels 24, 50 are spaced from each other to define an opening 52 therebetween. The first and second fixed panels 24, 50 are typically formed of glass. However, it is to be appreciated that the first and second fixed panels 24, 50 can be formed of any suitable material(s) such as plastic, metal, etc.

Turning to FIGS. 2, 7, and 8, the sliding window assembly 20 further includes a track 54 coupled to the fixed panel 24 and a sliding panel 56 movably coupled to the track 54 such that the sliding panel 56 moves relative to the fixed panel 24 between an open position and a closed position. The sliding panel 56 uncovers the opening 52 when in the open position as shown in FIG. 6 and the sliding panel 56 covers the opening 52 when in the closed position as shown in FIGS. 1, 7-9, 11, 14, and 15. It is to be appreciated that the sliding panel 56 is in the open position when the sliding panel 56 is partially covering the opening 52. In other words, the sliding panel 56 is in the open position when the sliding panel 56 is completely or partially uncovering the opening 52. The sliding panel 56 is in the closed position when the sliding panel 56 completely covers the opening 52. The sliding panel 56 typically moves horizontally relative to the first 24 and/or second 50 fixed panels. It is to be appreciated that the sliding panel 56 can move in any other suitable direction, such as, for example, vertically. The sliding panel 56 is typically formed of glass. However, it is to be appreciated that the sliding panel 56 can be formed of any suitable material(s) such as plastic, metal, etc.

The sliding panel 56 and the first and second fixed panels 24, 50 each have an interior surface 58 facing an interior 60 of the vehicle 22 when the sliding window assembly 20 is coupled to the vehicle 22. In addition, the sliding panel 56 and the first and second fixed panels 24, 50 each have an exterior surface 62 opposing the interior surface 58 of respective panels 24, 50, 56 such that the exterior surface 62 faces an exterior 64 of the vehicle 22 when the sliding window assembly 20 is coupled to the vehicle 22. The interior surface 58 is shown in FIGS. 2, 7-11, 14-16, 19, and 20 and the exterior surface 62 is shown in FIGS. 1 and 6.

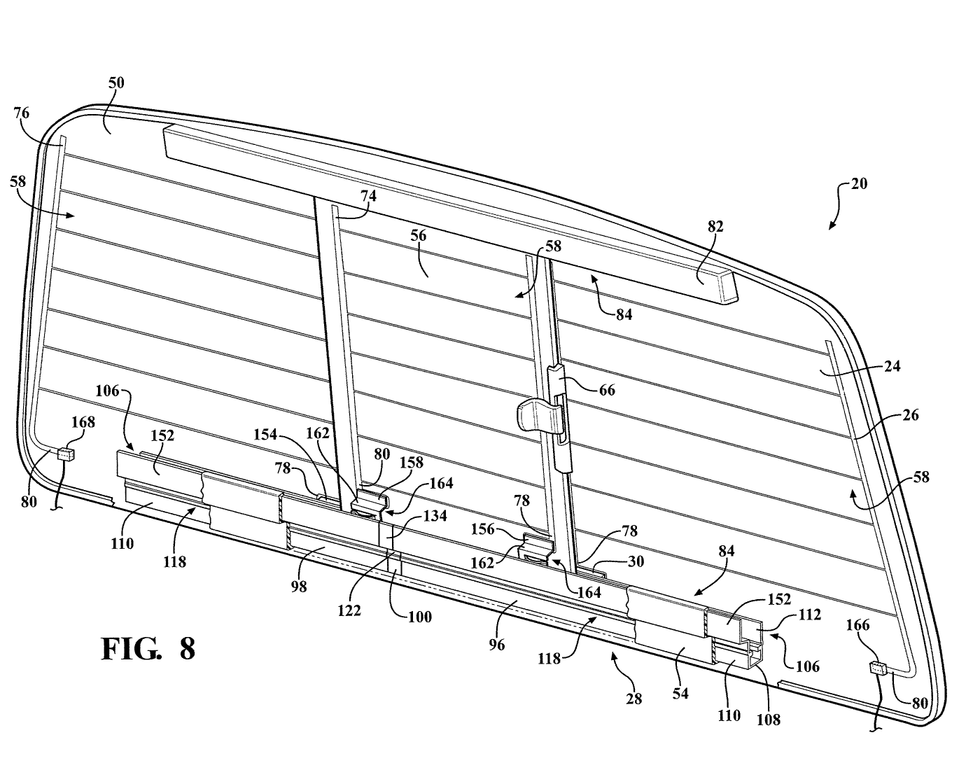

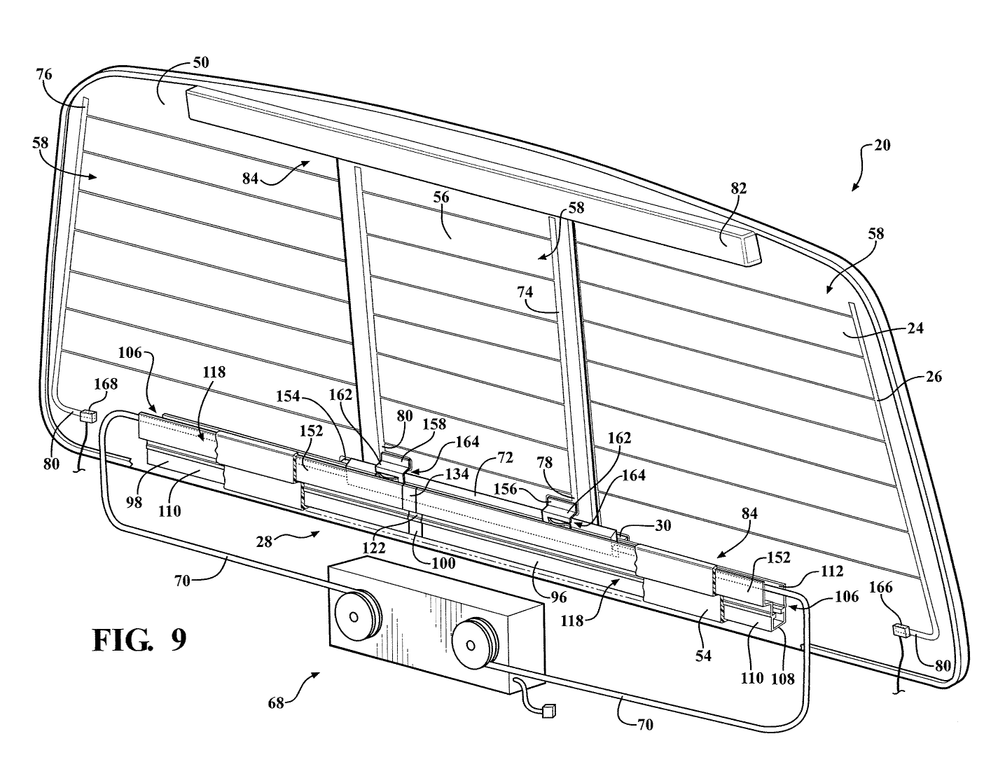

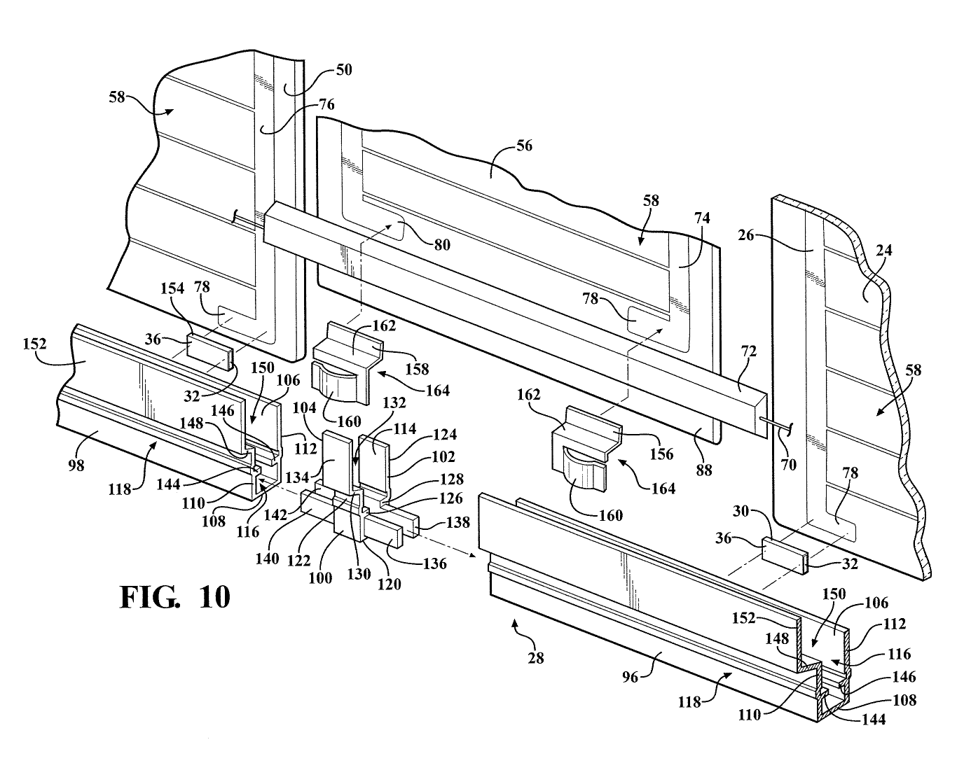

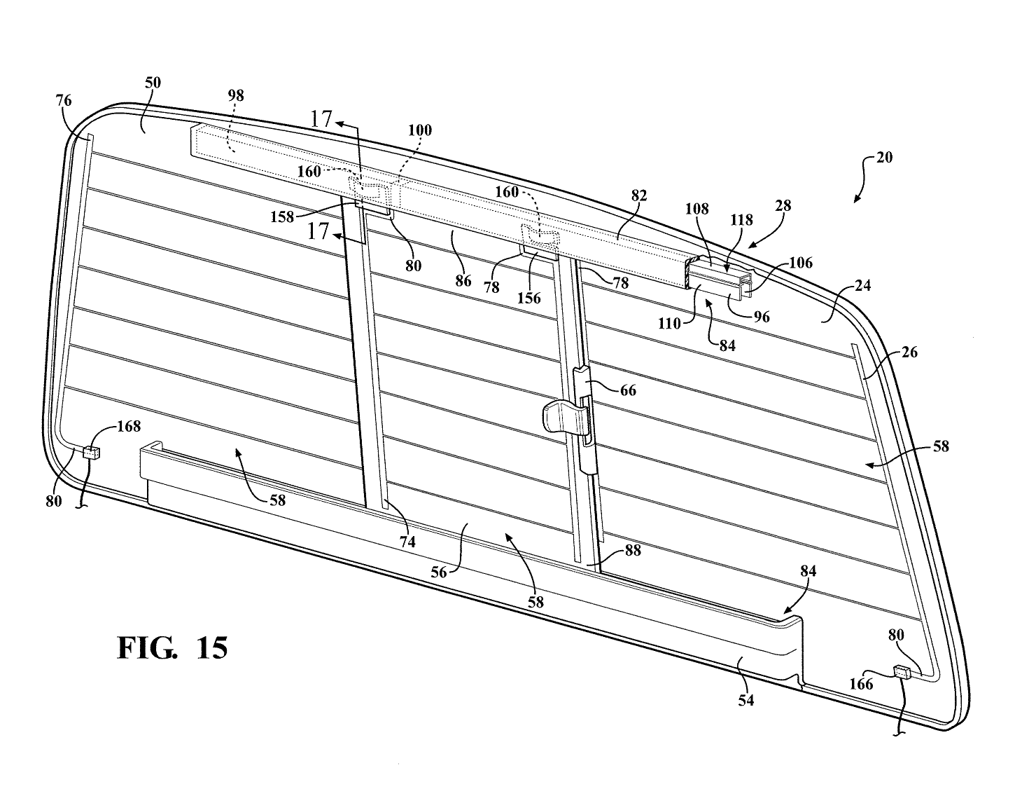

The sliding panel 56 is movable between the open and closed positions either manually or automatically. For example, as shown in FIGS. 8 and 15, a latch 66 can be attached to the sliding panel 56 to manually move the sliding panel 56 between the open and closed positions. As another example, as best shown in FIG. 9, a cable-motor power system 68 can be utilized to move the sliding panel 56 automatically; hence, the latch 66 can optionally be eliminated. The cable-motor power system 68 can include a cable(s) 70 and a bracket 72 coupled to the sliding panel 56 for moving the sliding panel 56 between the open and closed position (also see FIGS. 10, 19, and 20). It is to be appreciated that the bracket 72 can be coupled to the sliding panel 56 in any suitable location. Typically, the cable 70 is coupled to the bracket 72 to enable the cable 70 to move the bracket 72 which moves the sliding panel 56 between the open and closed positions. The bracket 72 transfers the force from the cable 70 to the sliding panel 56 for moving the sliding panel 56 within the track 54. As best shown in FIGS. 10, 19, and 20, the bracket 72 typically spans an entire length of the sliding panel 56. It is to be appreciated that the bracket 72 can be any suitable length. It is to be appreciated that the latch 66 can be utilized with any of the embodiments discussed herein and likewise, the cable-motor power system 68 can be utilized with any of the embodiments discussed herein.

The bracket 72 is typically coupled to the sliding panel 56 by any suitable method, such as, for example, taping, encapsulation, molding, bonding, etc. Generally, encapsulation results in an encapsulant that can be used to couple the bracket 72 to the sliding panel 56. In addition, encapsulation can be further defined as single-sided encapsulation, two-sided encapsulation, or three-sided encapsulation. For example, with single-sided encapsulation, the bracket 72 is coupled to the interior surface 58 of the sliding panel 56 leaving the exterior surface 62 of the sliding panel 56 free of the encapsulant. When encapsulation is employed, the bracket 72 is formed, at least partially, from the encapsulant. More specifically, with respect to encapsulation, the bracket 72 is formed of the encapsulant and is coupled to the sliding panel 56 by encapsulation. It is to be appreciated that any type of encapsulation or adhesive surface bonding can be utilized for coupling the bracket 72 to the sliding panel 56. The bracket 72 is typically formed of a plastic material(s), such as for example, polybutylene terephthalat (PBT). It is to be appreciated that the bracket 72 can be formed of any suitable material(s).

Referring back to FIGS. 8 and 9, the sliding window assembly 20 further includes a second heating grid 74 or center heating grid 74 coupled to the sliding panel 56 for defrosting the sliding panel 56 with the first and second heating grids 26, 74 electrically connected in a series circuit. In certain embodiments, a third heating grid 76 or right heating grid 76 is coupled to the second fixed panel 50 for defrosting the second fixed panel 50 with the first, second, and third heating grids 26, 74, 76 electrically connected in the series circuit. As suggested above, the first heating grid 26 is also referred to as the left heating grid 26, the second heating grid 74 is also referred to as the center heating grid 74, and the third heating grid 76 is also referred to as the right heating grid 76.

The first, second, and third heating grids 26, 74, 76 are typically coupled on the same side of the respective panels 24, 50, 56. More typically, the first, second, and third heating grids 26, 74, 76 are coupled to the interior surface 58 of the respective panels 24, 50, 56. It is to be appreciated that the first, second, and third heating grids 26, 74, 76 can be coupled to the exterior surface 62 of the respective panels 24, 50, 56 and/or any other suitable location.

Each of the first, second, and third heating grids 26, 74, 76 include a first end 78 and a second end 80 spaced from the first end 78 of respective first, second, and third heating grids 26, 74, 76. The first and second ends 78, 80 of each of the first, second, and third heating grids 26, 74, 76 are typically disposed on the same side in a spaced relationship. In other words, the first and second ends 78, 80 of each of the first, second, and third heating grids 26, 74, 76 are disposed on the interior surface 58 of the respective panels 24, 50, 56. It is to be appreciated that the first and second ends 78, 80 of the first, second, and third heating grids 26, 74, 76 can be disposed on the exterior surface 62 of the respective panels 24, 50, 56 or any other suitable location.

The first, second, and third heating grids 26, 74, 76 are typically formed of a paste for allowing electrical current to flow through the heating grids 26 74, 76, which is discussed further below. The paste can be formed of silver, ceramic, and/or any other suitable material(s). For example, the first, second, and/or third heating grids 26, 74, 76 can be formed of silver frit for tempered glass or laminated glass. As another example, the first, second, and/or third heating grids 26, 74, 76 can be formed of wires(s) for laminated glass. The paste of the first, second, and third heating grids 26, 74, 76 are typically bonded to the respective panels 24, 50, 56. The first, second, and/or third heating grids 26, 74, 76 can also be formed by screen printing, wire(s) impregnated in polyvinyl butyral (PVB), and/or any other suitable method.

In certain embodiments, the track 54 is coupled to the first and second fixed panels 24, 50. In another embodiment, the track 54 is further defined as a first track 54 and further includes a second track 82 coupled to the fixed panel 24 above the first track 54 with the sliding panel 56 movably coupled to the first and second tracks 54, 82. In yet another embodiment, the second track 82 is coupled to the first and second fixed panels 24, 50 above the first track 54. Likewise, the first track 54 is coupled to the first and second fixed panels 24, 50. Hence, the sliding panel 56 is movably coupled to the first and second tracks 54, 82.

The first and second tracks 54, 82 each define a slot 84 facing each other for receiving and/or guiding the sliding panel 56. Even more specifically, the sliding panel 56 includes a top edge 86 and a bottom edge 88 spaced from each other with the bottom edge 88 disposed in the slot 84 of the first track 54 and the top edge 86 disposed in the slot 84 of the second track 82. When utilizing the cable-motor power system 68, the bracket 72 can be coupled to the sliding panel 56 adjacent the bottom edge 88. It is to be appreciated that the bracket 72 can be coupled at any suitable location on the sliding panel 56. Typically, the first and second tracks 54, 82 are disposed horizontally in a substantially spaced and parallel relationship such that the sliding panel 56 moves horizontally back and forth relative to the first and second fixed panels 24, 50. It is to be appreciated that the first and second tracks 54, 82 can be positioned in any other suitable orientation or location, such as, for example, vertically spaced such that the sliding panel 56 can move vertically up and down relative to the first and second fixed panels 24, 50.

The first and second tracks 54, 82 are typically coupled to the first and second fixed panels 24, 50 by any suitable method, such as for example, encapsulation, molding, bonding, etc. Generally, encapsulation results in an encapsulant that can be used to couple the first and second tracks 54, 82 to the first and second fixed panels 24, 50. In addition, encapsulation can be further defined as single-sided encapsulation, two-sided encapsulation, or three-sided encapsulation. For example, with single-sided encapsulation, the first and second tracks 54, 82 are coupled to the interior surface 58 of the first and second fixed panels 24, 50 leaving the exterior surface 62 of the first and second fixed panels 24, 50 free of the encapsulant. When encapsulation is employed, the first and second tracks 54, 82 are formed, at least partially, from the encapsulant. More specifically, with respect to encapsulation, the first and second tracks 54, 82 are formed of the encapsulant and are coupled to the first and second fixed panels 24, 50 by encapsulation. It is to be appreciated that any type of encapsulation or adhesive surface bonding can be utilized for coupling the first and second tracks 54, 82 to the first and second fixed panels 24, 50.

When utilizing encapsulation, the encapsulant is typically formed of a plastic material(s) and more typically, thermoplastic material(s) and/or themoset material(s). Even more typically, the plastic material is polyvinyl chloride (PVC). It is to be appreciated that the encapsulant can be formed of various plastic material(s), such as, for example, thermoplastic elastomers (TPE); elastomeric alloys, e.g. thermoplastic vulcanizates (TPV); thermoplastic polyolefins (TPO); thermoplastic styrene (TPS); polyurethane; and various different types of reaction injection molding (RIM) materials; and/or any other suitable material(s) for encapsulation. One example of a suitable polyurethane is commercially available from BASF Corporation under the tradename of COLO-FAST™, e.g. COLO-FAST™ LM-161.

In one embodiment, as shown in FIGS. 1 and 6, appliqué 90 is attached to the track 54. More specifically, one piece of appliqué 90 is attached to the first track 54 and another piece of appliqué 90 is attached to the second track 82. It is to be appreciated that the appliqué 90 can be attached to the first and/or second tracks 54, 82 and/or the encapsulant. Typically, the appliqué 90 is disposed in the opening 52 between the first and second fixed panels 24, 50 along the first and second tracks 54, 82. The appliqué 90 includes an external surface 92 aligning with the exterior surface 62 of first and second fixed panels 24, 50 such that the exterior and external surfaces 62, 92 are substantially flush relative each other. The appliqué 90 is typically formed of a plastic material, such as, for example, a polycarbonate plastic. It is to be appreciated that other plastic material(s), glass, metal, and/or any other suitable material(s) can be utilized for the appliqué 90. In the configuration where the encapsulant is the first and second tracks 54, 82, the appliqué 90 is typically attached to the first and second tracks 54, 82 by encapsulation. It is to be appreciated that the appliqué 90 can be attached to the first and second tracks 54, 82 by any suitable method, such as, for example, adhesive.

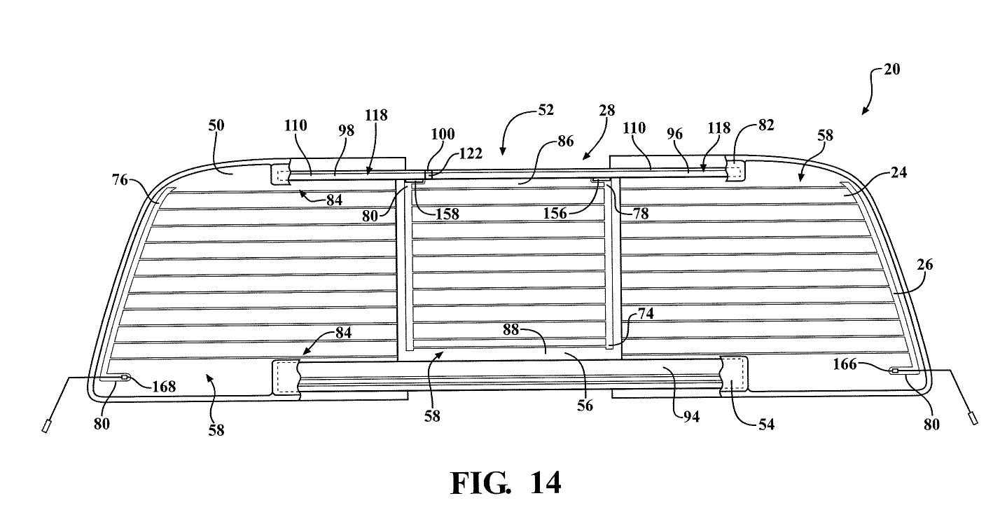

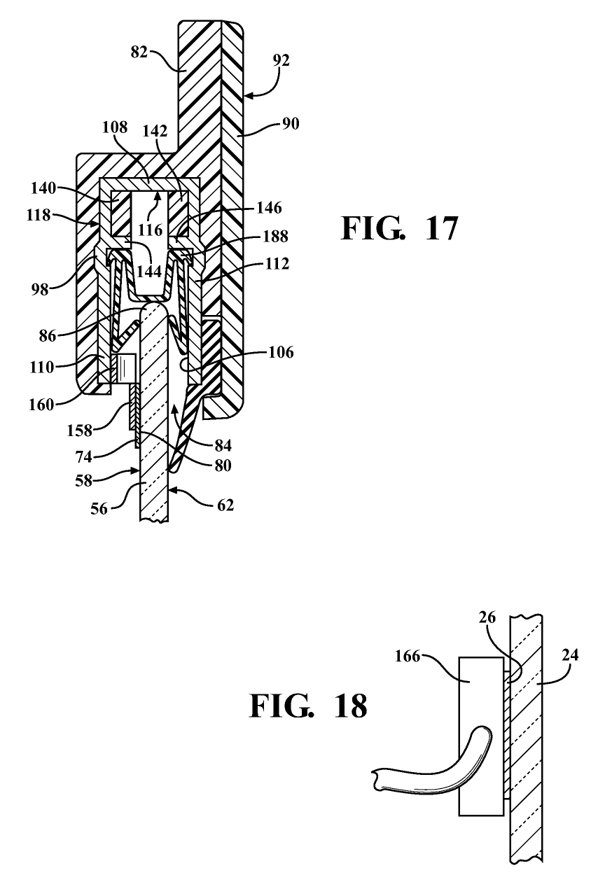

Referring to FIGS. 8 and 9, the sliding window assembly 20 further includes the conductive rail 28 coupled to the track 54. More specifically, the conductive rail 28 is coupled to one of the first and second tracks 54, 82. The conductive rail 28 is disposed in the slot 84 of one of the first and second tracks 54, 82. Hence, one of the first and second tracks 54, 82 can optionally be eliminated. In one embodiment, as shown in FIGS. 2, and 7-13, the conductive rail 28 is coupled to the first track 54. In another embodiment, as shown in FIGS. 14-17, the conductive rail 28 is coupled to the second track 82. The sliding window assembly 20 can optionally further include a rail 94 spaced from the conductive rail 28 with the sliding panel 56 movably coupled to the rail 94. Typically, currently flows through the conductive rail 28 as discussed below and no current flows through the rail 94. It is to be appreciated that current can flow through the rail 94.

For example, as shown in FIG. 7, the conductive rail 28 is coupled to the first track 54 and the rail 94 is coupled to the second track 82, and more specifically, the conductive rail 28 is disposed in the slot 84 of the first track 54 and the rail 94 is disposed in the slot 84 of the second track 82. As another example, as shown in FIG. 14, the rail 94 is coupled to the first track 54 and the conductive rail 28 is coupled to the second track 82, and more specifically, the rail 94 is disposed in the slot 84 of the first track 54 and the conductive rail 28 is disposed in the slot 84 of the second track 82. Hence, when the first and second tracks 54, 82 are spaced horizontally from each other, the conductive rail 28 and the rail 94 are correspondingly spaced horizontally from each other and when the first and second tracks 54, 82 are spaced vertically from each other, the conductive rail 28 and the rail 94 are correspondingly spaced vertically from each other. It is to be appreciated that various mechanical and electrical components can be re-orientated or relocated to accommodate vertical tracks 54, 82 and vertical rails 28, 94 for vertical movement of the sliding panel 56.

Typically, the conductive rail 28 is formed of a metal material(s), and more typically, the metal material is an alloy. Suitable alloys for the conductive rail 28 include aluminum and/or iron alloys, e.g. steel. In addition, the conductive rail 28 is further formed of a non-metal material(s), and more typically the non-metal material is a polymeric material(s), such as a plastic material(s). It is to be appreciated that the conductive rail 28 can include strips, etc. of conductive material; coated with any suitable material(s); and/or any other suitable material(s). For example, the conductive rail 28 can be anodized and/or e-coated aluminum. Further, the rail 94 can be formed of a metal material(s), such as an alloy. Suitable alloys for the rail 94 include aluminum and/or iron alloys, e.g. steel. The rail 94 can be formed of a non-conductive material(s), such as a non-metal material(s), polymeric material(s) and/or plastic material(s).

Turning to FIGS. 9-11, the conductive rail 28 includes a first conductive segment 96, a second conductive segment 98 spaced from the first conductive segment 96, and an insulator segment 100 disposed between the first and second conductive segments 96, 98. The first and second heating grids 26, 74 remain electrically connected to the first and second conductive segments 96, 98 in both the open and closed positions in the series circuit. Typically, the first and second conductive segments 96, 98 are formed of a metal material(s), and more typically, the metal material is an alloy. Suitable alloys for the first and second conductive segments 96, 98 include aluminum and/or iron alloys, e.g. steel. It is to be appreciated that the first and second conductive segments 96, 98 can include strips, etc. of conductive material; coated with any suitable material(s); and/or any other suitable material(s). For example, the first and second conductive segments 96, 98 can be anodized and/or e-coated aluminum.

The insulator segment 100 includes a first face 102 and a second face 104 spaced from each other with the first conductive segment 96 abutting the first face 102 and the second conductive segment 98 abutting the second face 104 for spacing apart the first and second conductive segments 96, 98. The insulator segment 100 can be formed of polymeric material(s) and more typically plastic material(s). The plastic material(s) can be thermoplastic material(s) and/or themoset material(s). In certain embodiments, the plastic material can be nylon or polyvinyl chloride (PVC). It is to be appreciated that the insulator segment 100 can be formed of various plastic material(s), such as, for example, polybutylene terephthalat (PBT); thermoplastic elastomers (TPE); elastomeric alloys, e.g. thermoplastic vulcanizates (TPV); thermoplastic polyolefins (TPO); thermoplastic styrene (TPS); polyurethane; polyamides, e.g. Zytel® commercially available from DuPont; and various different types of reaction injection molding (RIM) materials; and/or any other suitable material(s). One example of a suitable polyurethane is commercially available from BASF Corporation under the tradename of COLO-FAST™, e.g. COLO-FAST™ LM-161. It is to be appreciated that the insulator segment 100 can be formed of any non-conductive material(s). In other words, the insulator segment 100 can be any suitable material for inhibiting the flow of current between the first and second conductive segments 96, 98.

The first and second conductive segments 96, 98 each define a channel 106 for receiving the sliding panel 56. More specifically, the first conductive segment 96 includes a bottom 108, a first wall 110 extending from the bottom 108, and a second wall 112 spaced from the first wall 110 and extending from the bottom 108 to define the channel 106 therebetween for receiving the sliding panel 56. Likewise, the second conductive segment 98 includes a bottom 108, a first wall 110 extending from the bottom 108, and a second wall 112 spaced from the first wall 110 and extending from the bottom 108 to define the channel 106 therebetween for receiving the sliding panel 56. The channel 106 of the first and second conductive segments 96, 98 cooperate with each other for receiving and/or guiding the sliding panel 56. Additionally, the insulator segment 100 defines a channel 114 cooperating with the channel 106 of the first and second conductive segments 96, 98 for receiving and/or guiding the sliding panel 56. The channel 106 of the first and second segments 100, 96, 98, as well as the channel 114 of the insulator segment 100 can define a generally u-shaped configuration or any other suitable configuration. The channel 106 of the first and second conductive segments 96, 98 each have an inner surface 116 receiving the sliding panel 56 and an outer surface 118 opposing the inner surface 116 of respective segments 100, 96, 98. It is to be appreciated that the first and second segments 100, 96, 98 can be substantially the same configuration to each other or different. Likewise, it is to be appreciated that the rail 94 can be configured the same as the first and second conductive segments 96, 98, as such, the rail 94 can include the channel 106, the inner and outer surfaces 116, 118, etc.

The conductive rail 28 and the rail 94 can be coupled to the first and/or second tracks 54, 82 during encapsulation such that the encapsulant at least partially encompasses the outer surface 118 of the conductive rail 28 and the rail 94. In such an embodiment, the first and second tracks 54, 82 are each integral with the first and second fixed panels 24, 50. Specifically, the first track 54 is integral with the conductive rail 28 and the first and second fixed panels 24, 50. Likewise, the second track 82 is integral with the rail 94 and the first and second fixed panels 24, 50. In other words, the first and second tracks 54, 82 and the first and second fixed panels 24, 50 form a single continuous unit.

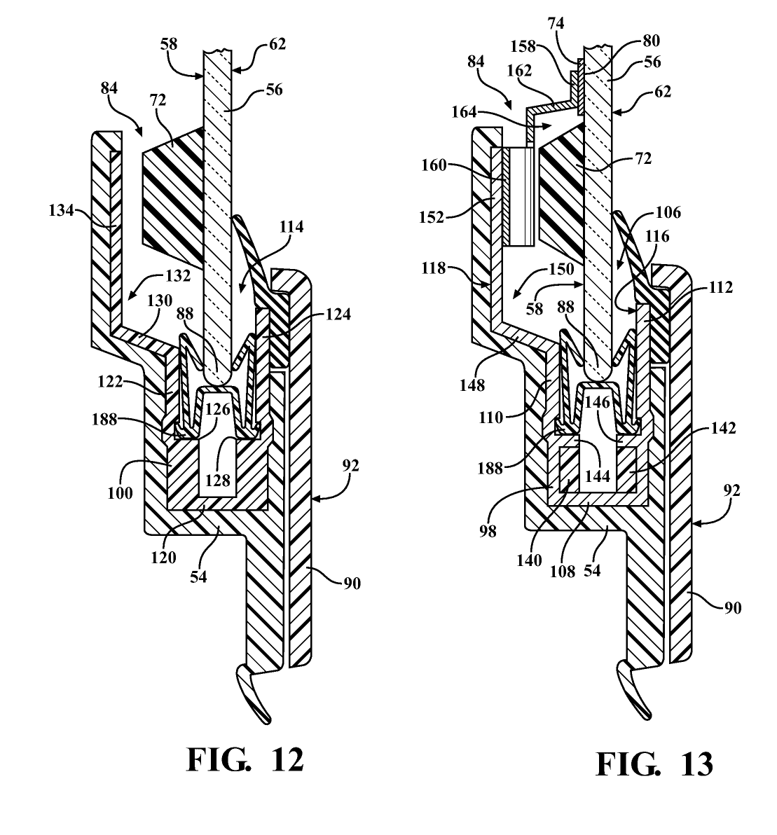

Also referring to FIG. 12, which is a cross-section through the insulator segment 100, the insulator segment 100 includes a base 120, a first side 122 extending from the base 120, and a second side 124 spaced from the first side 122 and extending from the base 120 to define the channel 114 therebetween for receiving the sliding panel 56. The first side 122 includes a first shoulder 126 extending toward the second side 124 and the second side 124 includes a second shoulder 128 extending toward the first side 122. The first and second shoulders 126, 128 are spaced from each other. The first side 122 further includes a lip 130 spaced from the first shoulder 126 and the base 120 to define a recess 132 adjacent the channel 114 of the insulator segment 100. The lip 130 extends outwardly away from the second side 124 to further define the recess 132 adjacent the channel 114 of the insulator segment 100. The first side 122 further includes an arm 134 extending upwardly from the lip 130 to further define the recess 132. The recess 132 can be utilized for water management components, the cable 70, the bracket 72, the sliding panel 56, and/or any other suitable components.

The first side 122 further includes a first flange 136 disposed between the base 120 and the first shoulder 126. The first flange 136 extends outwardly away from the channel 114 of the insulator segment 100 for receiving the first conductive segment 96. Likewise, the second side 124 includes a second flange 138 disposed between the base 120 and the second shoulder 128. The second flange 138 extends outwardly away from the channel 114 of the insulator segment 100 adjacent the first flange 136 for receiving the first conductive segment 96. The first side 122 further includes a third flange 140 disposed between the base 120 and the first shoulder 126. The third flange 140 extends outwardly away from the channel 114 of the insulator segment 100 for receiving the second conductive segment 98. Likewise, the second side 124 further includes a fourth flange 142 disposed between the base 120 and the second shoulder 128. The fourth flange 142 extends outwardly away from the channel 114 of the insulator segment 100 adjacent the third flange 140 for receiving the second conductive segment 98.

The first wall 110 of the first conductive segment 96 includes a first projection 144 extending toward the second wall 112 and the second wall 112 of the first conductive segment 96 includes a second projection 146 extending toward the first wall 110. The first and second flanges 136, 138 are disposed in the channel 106 of the first conductive segment 96 between the bottom 108 and the first and second projections 144, 146 respectively of the first conductive segment 96. Hence, the first and second flanges 136, 138 couple the insulator segment 100 and the first conductive segment 96 together. Likewise, the first wall 110 of the second conductive segment 98 includes a first projection 144 extending toward the second wall 112 and the second wall 112 of the second conductive segment 98 includes a second projection 146 extending toward the first wall 110. As shown in FIG. 13, the third and fourth flanges 140, 142 are disposed in the channel 106 of the second conductive segment 98 between the bottom 108 and the first and second projections 144, 146 respectively of the second conductive segment 98. Hence, the third and fourth flanges 140, 142 couple the insulator segment 100 and the second conductive segment 98 together. As such, the insulator segment 100 and the first and second conductive segments 96, 98, appear to form one continuous rail 28 when coupled together. In other words, the first and second conductive segments 96, 98, and the insulator segment 100 align with each other in a row to form one conductive rail 28. It is to be appreciated that the insulator segment 100 can be any suitable configuration and/or disposed between the first and second conductive segments 96, 98 by any suitable method, such as for example, bonding, welding, adhesive, encapsulation, fasteners, etc.

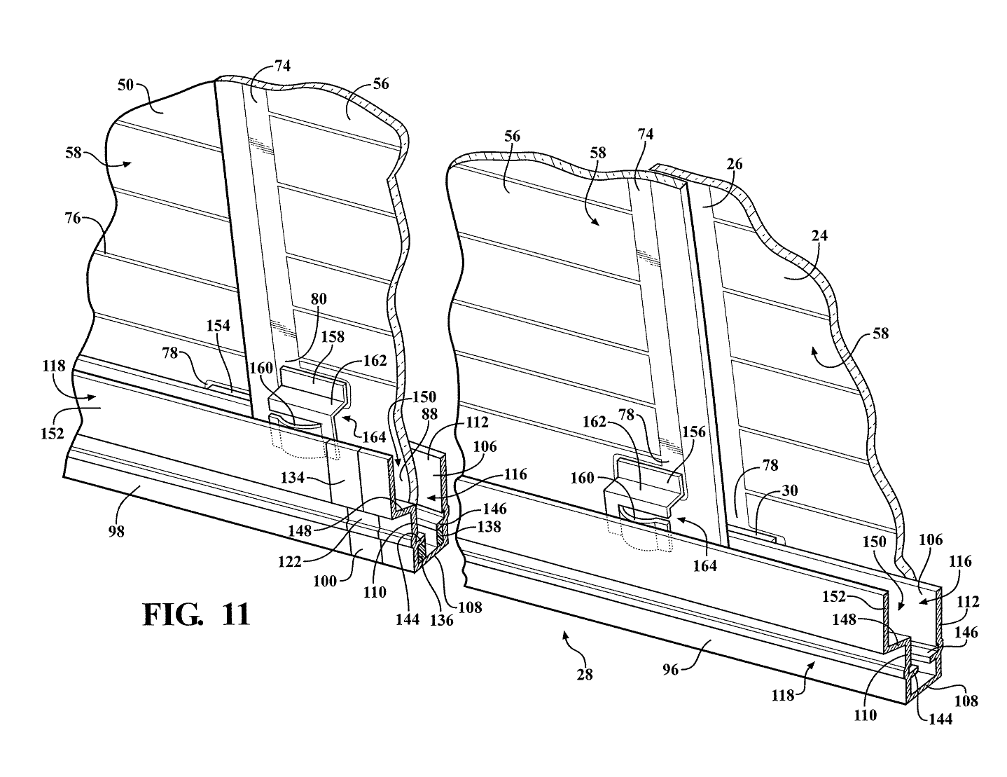

Referring back to FIGS. 10 and 11, the first wall 110 of the first and second conductive segments 96, 98 each include a finger 148 spaced from the first projection 144 and the bottom 108 to define a gap 150 adjacent the channel 106 of the first and second conductive segments 96, 98, respectively. The finger 148 extends outwardly away from the second wall 112 to further define the gap 150 adjacent the channel 106 of the first and second conductive segments 96, 98 respectively. The first wall 110 further includes a distal arm 152 extending upwardly from the finger 148 to further define the gap 150. The finger 148, the distal arm 152, and the gap 150 of the first and second conductive segments 96, 98 cooperate with the lip 130, the arm 134, and the recess 132 of the insulator segment 100. As such, the gap 150 of the first and second conductive segments 96, 98 can be utilized for water management components, the cable 70, the bracket 72, the sliding panel 56, and/or any other suitable components.

The first and second conductive segments 96, 98, as well as the insulator segment 100 can define different configurations or orientations. For example, as best shown in FIGS. 10 and 11, when the conductive rail 28 is disposed in the first track 54, the first and second conductive segments 96, 98 each include the finger 148, the distal arm 152, and the gap 150, and the insulator segment 100 includes the lip 130, the arm 134, and the recess 132. As another example, as best shown in FIGS. 14-17, the conductive rail 28 is disposed in the second track 82 such that the lip 130, the recess 132, the arm 134, the finger 148, the gap 150 and the distal arm 152 can optionally be eliminated. It is to be appreciated that the rail 94 (which does not include the insulator segment 100) can define different configurations or orientations as shown in FIGS. 7 and 14. For example, as shown in FIG. 7, when the rail 94 is disposed in the second track 82, the rail 94 can be configured similarly to the first conductive segment 96 without the finger 148, the gap 150, and the distal arm 152. As another example, as shown in FIG. 14, when the rail 94 is disposed in the first track 54, the rail 94 can be configured similarly to the first conductive segment 96 with the finger 148, the gap 150, and the distal arm 152. It is to be appreciated that the conductive rail 28 and the rail 94 can be any suitable configuration.

Referring back to FIGS. 2, 8, 10, and 11, the sliding window assembly 20 can further include a first connector 30 disposed between the first heating grid 26 and the first conductive segment 96 for electrically connecting the first heating grid 26 to the first conductive segment 96 such that the first and second heating grids 26, 74 remain electrically connected to the first and second conductive segments 96, 98 in both the open and closed positions in the series circuit. Additionally, the sliding window assembly 20 can further include a second connector 154 disposed between the third heating grid 76 and the second conductive segment 98 for electrically connecting the third heating grid 76 to the second conductive segment 98 such that the first, second, and third heating grids 26, 74, 76 remain electrically connected to the first and second conductive segments 96, 98 in both the open and closed positions in the series circuit. Typically, the first connector 30 is disposed on the first end 78 of the first heating grid 26 and the second connector 154 is disposed on the first end 78 of the third heating grid 76. It is to be appreciated that the first and second connectors 30, 154 can be at any suitable location on the first and third heating grids 26, 76 respectively.

The first connector 30 is compressed between the first conductive segment 96 and the first fixed panel 24, and more specifically compressed between the first conductive segment 96 and the first heating grid 26. Likewise, the second connector 154 is compressed between the second conductive segment 98 and the second fixed panel 50, and more specifically compressed between the second conductive segment 98 and the third heating grid 76. Typically, the first and second connectors 30, 154 are compressed before encapsulating the conductive rail 28. Encapsulation maintains the orientation, location, and/or compression of the first and second connectors 30, 154 relative to the first and second conductive segments 96, 98 respectively and the first and third heating grids 26, 76 respectively. It is to be appreciated that the connectors 30 can be compressed at any suitable step of assembling the components. The first and second connectors 30, 154 are compressed to take up space between the first and second conductive segments 96, 98 respectively and the first and third heating grids 26, 76 respectively due to manufacturing tolerances of the conductive rail 28, the first 26 and/or third 76 heating grids, and/or the first 24 and/or second 50 fixed panels. In addition, having the first and second connectors 30, 154 compressible prevent breakage of the first and second fixed panels 24, 50 during assembly of the first and second connectors 30, 154 between the first and third heating grids 26, 76 and the first and second conductive segments 96, 98. The specifics of the first and second connectors 30, 154 have been discussed above for the connector/conductive connector 30.

Also referring to FIG. 5, the first connector 30 is coupled to the outer surface 118 of the first conductive segment 96 and the second connector 154 coupled to the outer surface 118 of the second conductive segment 98. In certain embodiments, the first and second connectors 30, 154 each comprise foam. In addition, the first and second connectors 30, 154 each further comprise a foil layer 36 surrounding the foam respectively. The foil layer 36 of the first connector 30 defines a first conductive connector 30 and the foil layer 36 of the second connector 154 defines a second conductive connector 154. The foil layer 36 of the first and second connectors 30, 154 each have a first surface 38 and a second surface 40 opposing the first surface 38 respectively. The first and second connectors 30, 154 each further comprise the adhesive layer 46 abutting at least one of the first and second surfaces 38, 40 of the foil layer 36 respectively. More specifically, the adhesive layer 46 of the first connector 30 abuts at least one of the first and second surfaces 38, 40 of the foil layer 36 of the first connector 30 and at least one of the first conductive segment 96 and the first heating grid 26 for coupling the first conductive connector 30 thereon. Likewise, the adhesive layer 46 of the second connector 154 abuts at least one of the first and second surfaces 38, 40 of the foil layer 36 of the second connector 154 and at least one of the second conductive segment 98 and the third heating grid 76 for coupling the second conductive connector 154 thereon. It is to be appreciated that the first and second conductive connectors 30, 154 are formed as discussed above for the connector/conductive connector 30 and can be substantially the same configuration. FIG. 5 is representative of either of the first or second conductive connectors 30, 154. It is to be appreciated that the first and second connectors 30, 154 can be configured differently from each other.

The sliding window assembly 20 can further include a first slide connector 156 disposed between the second heating grid 74 and the first conductive segment 96 for electrically connecting the second heating grid 74 to the first conductive segment 96. In addition, the sliding window assembly 20 can further include a second slide connector 158 disposed between the second heating grid 74 and the second conductive segment 98 for electrically connecting the second heating grid 74 to the second conductive segment 98. The first and second slide connectors 156, 158 are spaced from each other. Typically, the first slide connector 156 is disposed on the first end 78 of the second heating grid 74 and the second slide connector 158 is disposed on the second end 80 of the second heating grid 74. It is to be appreciated that the first and second slide connectors 156, 158 can be at any suitable location on the second heating grid 74.

The first and second slide connectors 156, 158 are coupled to the sliding panel 56 and movable with the sliding panel 56 between the open and closed positions. It is to be appreciated that the insulator segment 100 can be at any suitable location depending on the direction the sliding panel 56 moves between the open and closed positions. For example, as shown in FIG. 2, the insulator segment 100 is adjacent the first slide connector 156 when the sliding panel 56 is in the closed position. Hence, as the sliding panel 56 moves to the open position, the second slide connector 158 moves toward the insulator segment 100. As another example, as shown in FIGS. 7-9, 11, 14, and 15, the insulator segment 100 is adjacent the second slide connector 158 when the sliding panel 56 is in the closed position. Hence, as the sliding panel 56 moves to the open position, the first slide connector 156 moves toward the insulator segment 100.

The first and second slide connectors 156, 158 are typically formed of any suitable metal material for electrically connecting the second heating grid 74 to the first and second conductive segments 96, 98. In addition, the first and second slide connectors 156, 158 are typically soldered to the second heating grid 74 but can be secured to the second heating grid 74 by any suitable method, such as for example, welding, bonding, adhesive, fasteners, etc. It is to be appreciated that the first and second slide connectors 156, 158 can be any suitable configuration or orientation and the Figures are for illustrative purposes only. It is to further be appreciated that the conductive connectors 30, such as the first and second connectors 30, 154, can be utilized as the first and second slide connectors 156, 158 respectively. In other words, another conductive connector 30 can be utilized instead of the first slide connector 156 and yet another conductive connector 30 can be utilized instead of the second slide connector 158. It is to be appreciated when replacing the first and second slide connectors 156, 158 with the conductive connectors 30, additional support(s), covers, fasteners, adhesives, etc. can be utilized to add strength to the conductive connectors 30.

Referring to FIGS. 10, 11, and 13, the first and second slide connectors 156, 158 each include a biasing member 160 continuously engaging the first and second conductive segments 96, 98 respectively during movement of the sliding panel 56. In certain embodiments, the biasing member 160 of the first slide connector 156 engages the inner surface 116 of the first conductive segment 96 and the biasing member 160 of the second slide connector 158 engages the inner surface 116 of the second conductive segment 98. It is to be appreciated that the biasing member 160 of each of the first and second slide connectors 156, 158 typically do not engage the insulator segment 100. Hence, the first and second sides 122, 124 of the insulator segment 100 are typically disposed between the first and second slide connectors 156, 158. It is to be appreciated that the first and second slide connectors 156, 158 can overlap the insulator segment 100 while the biasing member 160 of each of the slide connectors 156, 158 remains in continuous engagement with the first and second conductive segments 96, 98 respectively for maintaining the electrically connection.

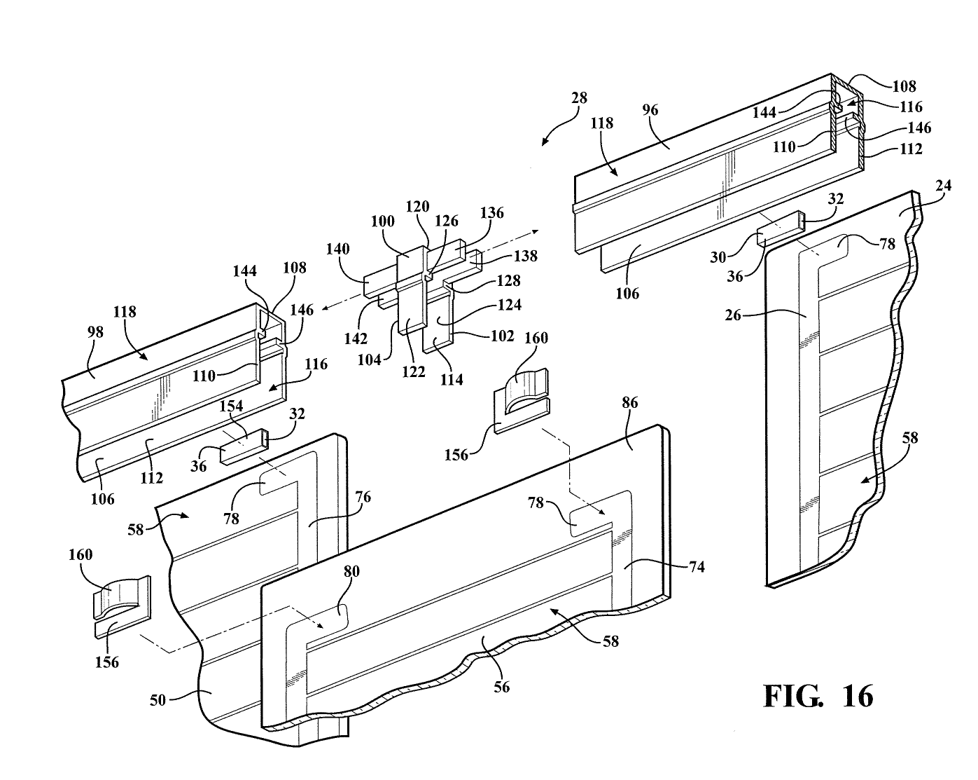

The first and second slide connectors 156, 158 each further include a leg 162 extending outwardly with the biasing member 160 extending from the leg 162. The leg 162 and the biasing member 160 cooperate to define a space 164. The space 164 can be utilized for water management components, the cable 70, the bracket 72, and/or any other suitable components. As shown in FIGS. 9 and 13, the bracket 72 is disposed in the space 164. It is to be appreciated that the leg 162 of the first and second slide connectors 156, 158 can be eliminated as best shown in FIG. 16. It is to be appreciated that the first and second slide connectors 156, 158 can be substantially the same configuration or configured different from each other as desired.

In addition, as shown in FIGS. 2, 7-9, 14, 15, and 18-20, the sliding window assembly 20 can further include a first terminal connector 166 coupled to the first heating grid 26 and spaced from the first connector 30 and a second terminal connector 168 coupled to the third heating grid 76 and spaced from the second connector 154. It is to be appreciated that the first and second terminal connectors 166, 168 can be substantially the same configuration and thus FIG. 18 is representative of either the first or second terminal connectors 166, 168. It is to further be appreciated that the first and second terminal connectors 166, 168 can be configured different from each other as desired. The first and second terminal connectors 166, 168 typically include wires extending outwardly with the wires coupled to a wire harness as discussed further below.

The first and second terminal connectors 166, 168 are typically formed of any suitable metal material for electrically connecting the first and third heating grids 26, 76 to the first and second conductive segments 96, 98. Further, the first and second terminal connectors 166, 168 are typically soldered to the first and third heating grids 26, 76 respectively but can be secured to the first and third heating grids 26, 76 respectively by any suitable method, such as for example, welding, bonding, adhesive, fasteners, etc. The first and second terminal connectors 166, 168 can be soldered to the first and third heating grids 26, 76 respectively either before or after forming the track 54 by encapsulation.

It is to be appreciated that the first and second terminal connectors 166, 168 can be any suitable configuration or orientation and the Figures are for illustrative purposes only. It is to be appreciated that the first and second terminal connectors 166, 168 can be at any suitable location on any of the heating grids 26, 74, 76 or the conductive rail 28. In one embodiment, as shown in FIGS. 7-9, 14, and 15, the first terminal connector 166 is disposed on the second end 80 of the first heating grid 26 and the second terminal connector 168 is disposed on the second end 80 of the third heating grid 76. In another embodiment, as shown in FIG. 2, the second terminal connector 168 is coupled to the second conductive segment 98. For this embodiment, it is to be appreciated that the second terminal connector 168 can be coupled to the second conductive segment 98 at any suitable location. Further, it is to be appreciated that the first terminal connector 166 can be coupled to the first conductive segment 96 instead of the first heating grid 26, etc. In addition, it is to be appreciated that the conductive connectors 30, such as the first and second connectors 30, 154, can be utilized as the first and second terminal connectors 166, 168 respectively. In other words, another conductive connector 30 can be utilized instead of the first terminal connector 166 and yet another conductive connector 30 can be utilized instead of the second terminal connector 168. It is to be appreciated when replacing the first and second terminal connectors 166, 168 with the conductive connectors 30, additional support(s), covers, fasteners, adhesives, etc. can be utilized to add strength to the conductive connectors 30.

A power supply of the vehicle 22 is electrically connected to the conductive rail 28 for flowing current, i.e. electrical current/electricity, through the first and second conductive segments 96, 98 of the conductive rail 28, as well as the first, second, and/or third heating grids 26, 74, 76. Typically, the first and second terminal connectors 166, 168 are utilized to electrically connect to the power supply for supplying current to the first and second conductive segments 96, 98, and the first, second, and/or third heating grids 26, 74, 76. As such, current flows in through one of the first and second terminal connectors 166, 168 and current flows out through an other one of the first and second terminal connectors 166, 168. Typically, the first and second terminal connectors 166, 168 are coupled to the wire harness which is coupled to the power supply. It is to be appreciated that any of the connectors 30, 154, 156, 158, 166, 168 discussed herein can be utilized to supply power to the first and second conductive segments 96, 98, and the first, second, and/or third heating grids 26, 74, 76. The power supply includes a first output electrically connected to the first conductive segment 96 and a second output electrically connected to the second conductive segment 98. For example, the first output of the power supply is a negative charge and the second output of the power supply is a positive charge. It is to be appreciated that the first output can be the positive charge and the second output can be the negative charge. Typically, the current is a direct current (DC). It is to be appreciated that any other suitable current can be utilized.

As discussed above, the first and second heating grids 26, 74, and more specifically, the first, second, and third heating grids 26, 74, 76 are electrically connected in the series circuit. For illustrative purposes only, below is a discussion of various embodiments of providing current to the first, second, and/or third heating grids 26, 74, 76 in the series circuit. As discussed above, current flows in and out through the first and second terminal connectors 166, 168 respectively. For purposes of the below discussion only, current will flow in through the first terminal connector 166 and out through the second terminal connector 168.

Referring to FIG. 2, the sliding window assembly 20 includes one fixed panel 24 and the sliding panel 56 with the conductive rail 28 coupled to the first track 54. Current flows in through the first terminal connector 166, through the first heating grid 26, through the first connector 30, through the first conductive segment 96, through the first slide connector 156, through the second heating grid 74, through the second slide connector 158, through the second conductive segment 98 and out the second terminal connector 168. Hence, the insulator segment 100 prevents current from flowing directly from the first conductive segment 96 to the second conductive segment 98. Further, the second heating grid 74 remains electrically connected to the first and second conductive segments 96, 98 during movement between the open and closed positions; therefore, current continuously flows through the first and second heating grids 26, 74. In other words, the electrical connection is not broken between the first and second heating grids 26, 74 when the sliding panel 56 moves between the open and closed positions.

Referring to FIGS. 7-11, the sliding window assembly 20 includes the first and second fixed panels 24, 50 and the sliding panel 56 with the conductive rail 28 coupled to the first track 54. Current flows in through the first terminal connector 166, through the first heating grid 26, through the first connector 30, through the first conductive segment 96, through the first slide connector 156, through the second heating grid 74, through the second slide connector 158, through the second conductive segment 98, through the second connector 154, through the third heating grid 76 and out the second terminal connector 168. Again, the insulator segment 100 prevents current from flowing directly from the first conductive segment 96 to the second conductive segment 98. Further, the second heating grid 74 remains electrically connected to the first and second conductive segments 96, 98 during movement between the open and closed positions, therefore, current continuously flows through the first, second, and third heating grids 26, 74, 76. In other words, the electrical connection is not broken between the first, second, and/or third heating grids 26, 74, 76 when the sliding panel 56 moves between the open and closed positions.

Referring to FIGS. 14-16, the sliding window assembly 20 includes the first and second fixed panels 24, 50 and the sliding panel 56 with the conductive rail 28 coupled to the second track 82. Current flows in through the first terminal connector 166, through the first heating grid 26, through the first connector 30, through the first conductive segment 96, through the first slide connector 156, through the second heating grid 74, through the second slide connector 158, through the second conductive segment 98, through the second connector 154, through the third heating grid 76 and out the second terminal connector 168. Again, the insulator segment 100 prevents current from flowing directly from the first conductive segment 96 to the second conductive segment 98. Further, the second heating grid 74 remains electrically connected to the first and second conductive segments 96, 98 during movement between the open and closed positions, therefore, current continuously flows through the first, second, and third heating grids 26, 74, 76. In other words, the electrical connection is not broken between the first, second, and/or third heating grids 26, 74, 76 when the sliding panel 56 moves between the open and closed positions.

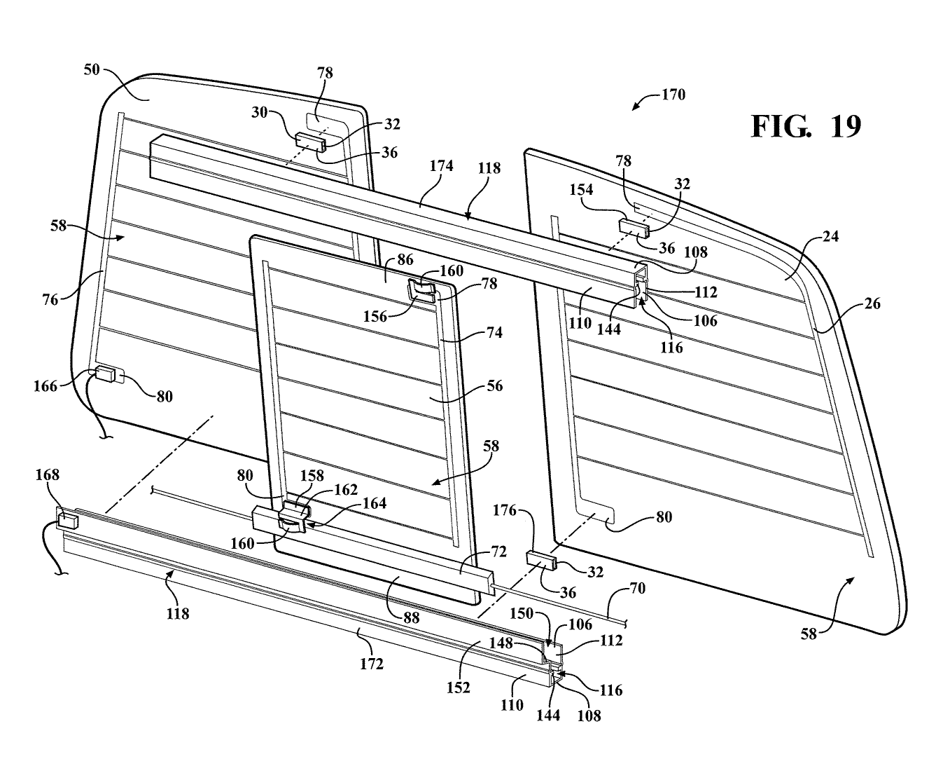

Referring to FIG. 19, a sliding window assembly 170 of an alternative embodiment is shown. In this configuration, the insulator segment 100 has been eliminated such that current flows through both a first rail 172 and a second rail 174. The track 54 as discussed above can be utilized with this embodiment, i.e., the first rail 172 coupled to the first track 54 and the second rail 174 coupled to the second track 82. It is to be appreciated that the first and second rails 172, 174 can be configured as discussed above for either the conductive rail 28 or the rail 94, i.e. including the finger 148, the distal arm 152, etc. or eliminating the finger 148, the distal arm 152, etc. It is to further be appreciated that the first and second rails 172, 174 can be formed of the same material(s) as discussed above for the first and second conductive segments 96, 98.

The sliding window assembly 170 further includes a third connector 176 coupled to one of the first and second rails 172, 174 and one of the first and third heating grids 26, 76 and includes the first and second connectors 30, 154. In this embodiment, the first and second connectors 30, 154 are coupled to the second rail 174 and the third connector 176 is coupled to the first rail 172. In addition, the second and third connectors 154, 176 are coupled to the first heating grid 26 and the first connector 30 is coupled to the third heating grid 76. The specifics of the third connector 176 has been discussed above for the connector/conductive connector 30 and can be substantially the same configuration as the first and second connectors 30, 154. It is to be appreciated that the third connector 176 can be configured differently from the first and/or second connectors 30, 154. In this embodiment, one of the first and second terminal connectors 166, 168 is coupled to one of the first and second rails 172, 174 and the first slide connector 156 engages the second rail 174 and the second slide connector 158 engages the first rail 172. It is to be appreciated that the first and second slide connectors 156, 158 can be configured different as shown in FIG. 19 or substantially the same, i.e., including the leg 162 or eliminating the leg 162, etc.

Current flows in through the first terminal connector 166, through the third heating grid 76, through the first connector 30, through the second rail 174, through the second connector 154, through the first heating grid 26, through the third connector 176, through the first rail 172 and out the second terminal connector 168 such that the first and third heating grids 26, 76 are in the series circuit. Further, in this configuration, the second and third heating grids 74, 76 are in the series circuit, such that when current flows in the second rail 174, then current also flows through the first slide connector 156, through the second heating grid 74, through the second slide connector 158, through the first rail 172 and out the second terminal connector 168. Hence, the first and second heating grids 26, 74 are in a parallel circuit.

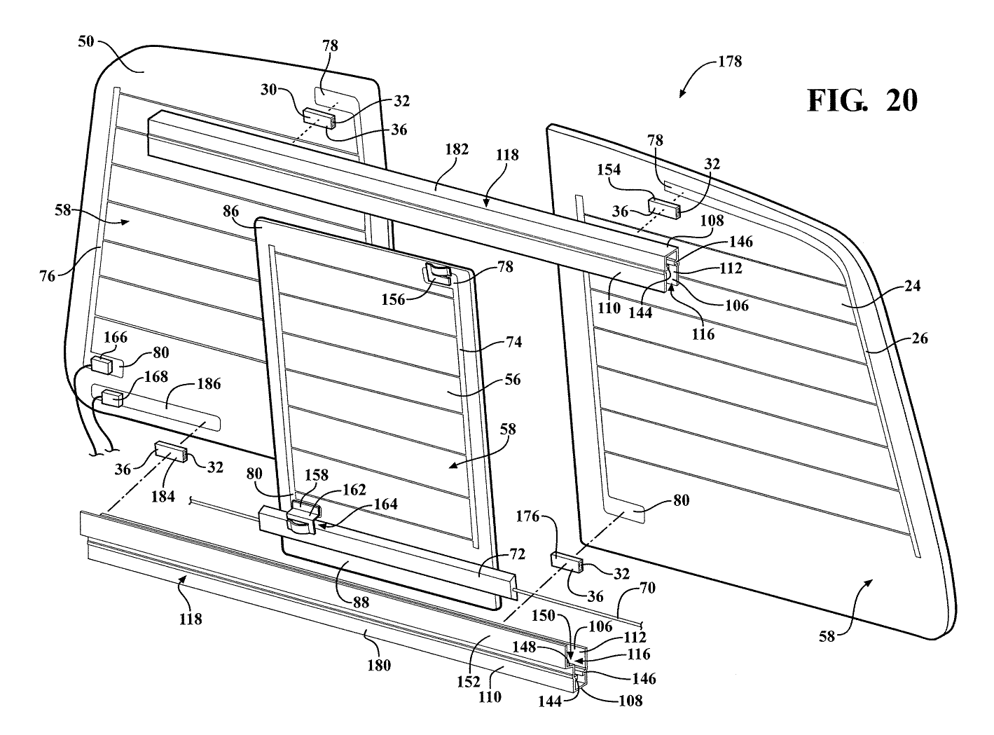

Referring to FIG. 20, a sliding window assembly 178 of an alternative embodiment is shown. In this configuration, the insulator segment 100 has also been eliminated such that current flows through both a first rail 180 and a second rail 182. The track 54 as discussed above can be utilized with this embodiment, i.e., the first rail 180 coupled to the first track 54 and the second rail 182 coupled to the second track 82. It is to be appreciated that the first and second rails 180, 182 can be configured as discussed above for either the conductive rail 28 or the rail 94, i.e. including the finger 148, the distal arm 152, etc. or eliminating the finger 148, the distal arm 152, etc. It is to further be appreciated that the first and second rails 180, 182 can be formed of the same material(s) as discussed above for the first and second conductive segments 96, 98.

The sliding window assembly 178 includes a fourth connector 184 coupled to one of the first and second rails 180, 182 and includes the first, second, and third connectors 30, 154, 176. In this embodiment, one of the first and third heating grids 26, 76 includes a strip 186 spaced from the respective first and third heating grids 26, 76. The strip 186 is formed of the same material(s) as discussed above for the heating grids 26, 74, 76 or any other suitable material(s). The first and second connectors 30, 154 are coupled to the second rail 182 and the third and fourth connectors 176, 184 are coupled to the first rail 180. In addition, the second and third connectors 154, 176 are coupled to the first heating grid 26, the first connector 30 is coupled to the third heating grid 76, and the fourth connector 184 is coupled to the strip 186. The specifics of the fourth connector 184 has been discussed above for the connector/conductive connector 30 and can be substantially the same configuration as the first, second, and third connectors 30, 154, 176. It is to be appreciated that the fourth connector 184 can be configured differently from the first, second, and/or third connectors 30, 154, 176. In this configuration, the fourth connector 184 is compressed between the first rail 180 and the strip 186. Further in this embodiment, one of the first and second terminal connectors 166, 168 is coupled to the strip 186 and the first slide connector 156 engages the second rail 182 and the second slide connector 158 engages the first rail 180. It is to be appreciated that the first and second slide connectors 156, 158 can be configured different as shown in FIG. 20 or substantially the same, i.e., including the leg 162 or eliminating the leg 162, etc.

Current flows in through the first terminal connector 166, through the third heating grid 76, through the first connector 30, through the second rail 182, through the second connector 154, through the first heating grid 26, through the third connector 176, through the first rail 180, through the fourth connector 184, through the strip 186 and out the second terminal connector 168 such that the first and third heating grids 26, 76 are in the series circuit. Further, in this configuration, the second and third heating grids 74, 76 are in the series circuit, such that when current flows in the second rail 182, then current also flows through the first slide connector 156, through the second heating grid 74, through the second slide connector 158, through the first rail 180, through the fourth connector 184, through the strip 186 and out the second terminal connector 168. Hence, the first and second heating grids 26, 74 are in a parallel circuit.

For illustrative purposes only, some of the details of at least FIGS. 2, 7-11, 14-16, 19 and 20 are not shown for illustrating other components of the present invention. For example, in FIGS. 2 and 14, the cable-motor power system 68 or the latch 66 is not shown. As another example, in FIGS. 10, 11, 16, 19, and 20, the track 54 is not shown. It is to be appreciated that any of the above embodiments of the sliding window assembly 20, 170, 178 can optional further include an insert 188, seals, etc. Further, it is to be appreciated that various mechanical and electrical components of the present invention can be re-orientated or relocated to accommodate various other mechanical and electrical components. Further, it is to be appreciated that the cable 70, the bracket 72, the first, second, third, and fourth connectors 30, 154, 176, 184, the first and second slide connectors 156, 158 are typically hidden from a user's sight but it is to be appreciated that these components do not have to be hidden. It is to be appreciated that other components can be hidden from the user's sight if desired.

Many modifications and variations of the present invention are possible in light of the above teachings. The foregoing invention has been described in accordance with the relevant legal standards; thus, the description is exemplary rather than limiting in nature. Variations and modifications to the disclosed embodiment can become apparent to those skilled in the art and do come within the scope of the invention. Accordingly, the scope of legal protection afforded this invention can only be determined by studying the following claims.

What is claimed is:

1. A sliding window assembly for a vehicle, said assembly comprising:
a fixed panel adapted to be fixed to the vehicle;
a first heating grid coupled to said fixed panel for defrosting said fixed panel;
a track coupled to said fixed panel;
a sliding panel movably coupled to said track such that said sliding panel moves relative to said fixed panel between an open position and a closed position;
a second heating grid coupled to said sliding panel for defrosting said sliding panel with said first and second heating grids electrically connected in a series circuit; and
a conductive rail coupled to said track and including a first conductive segment, a second conductive segment spaced from said first conductive segment, and an insulator segment disposed between said first and second conductive segments with said first and second heating grids remaining electrically connected to said first and second conductive segments in both said open and closed positions in said series circuit.

2. A sliding window assembly as set forth in claim 1 further including a first connector disposed between said first heating grid and said first conductive segment for electrically connecting said first heating grid to said first conductive segment such that said first and second heating grids remain electrically connected to said first and second conductive segments in both said open and closed positions in said series circuit.

3. A sliding window assembly as set forth in claim 2 wherein said first conductive segment defines a channel for receiving said sliding panel with said channel of said first conductive segment has an inner surface receiving said sliding panel and an outer surface opposing said inner surface with said first connector coupled to said outer surface of said first conductive segment.

4. A sliding window assembly as set forth in claim 2 further including a first slide connector disposed between said second heating grid and said first conductive segment for electrically connecting said second heating grid to said first conductive segment.

5. A sliding window assembly as set forth in claim 4 further including a second slide connector disposed between said second heating grid and said second conductive segment for electrically connecting said second heating grid to said second conductive segment with said first and second slide connectors spaced from each other.

6. A sliding window assembly as set forth in claim 5 further including a first terminal connector coupled to said first heating grid and spaced from said first connector.

7. A sliding window assembly as set forth in claim 6 further including a second terminal connector coupled to said second conductive segment.

8. A sliding window assembly as set forth in claim 2 wherein said first connector comprises foam.

9. A sliding window assembly as set forth in claim 8 wherein said first connector further comprises a foil layer surrounding said foam to define a first conductive connector.

10. A sliding window assembly as set forth in claim 9 wherein said foil layer has a first surface and a second surface opposing said first surface and said first connector further comprises an adhesive layer abutting at least one of said first and second surfaces of said foil layer and at least one of said first conductive segment and said first heating grid for coupling said first conductive connector thereon.

11. A sliding window assembly as set forth in claim 1 wherein said fixed panel is further defined as a first fixed panel and further including a second fixed panel adapted to be fixed to the vehicle such that said first and second fixed panels are spaced from each other to define an opening therebetween with said sliding panel uncovering said opening when in said open position and said sliding panel covering said opening when in said closed position and wherein a third heating grid is coupled to said second fixed panel for defrosting said second fixed panel.

12. A sliding window assembly as set forth in claim 11 further including a second connector disposed between said third heating grid and said second conductive segment for electrically connecting said third heating grid to said second conductive segment such that said first, second, and third heating grids remain electrically connected to said first and second conductive segments in both said open and closed positions in said series circuit.

13. A sliding window assembly as set forth in claim 12 further including a first connector disposed between said first heating grid and said first conductive segment for electrically connecting said first heating grid to said first conductive segment such that said first and second heating grids remain electrically connected to said first and second conductive segments in both said open and closed positions in said series circuit.

14. A sliding window assembly as set forth in claim 13 wherein said first and second conductive segments each define a channel cooperating with each other for receiving said sliding panel with said channel of said first and second conductive segments each have an inner surface receiving said sliding panel and an outer surface opposing said inner surface of respective segments with said first connector coupled to said outer surface of said first conductive segment and said second connector coupled to said outer surface of said second conductive segment.

15. A sliding window assembly as set forth in claim 13 further including a first slide connector disposed between said second heating grid and said first conductive segment for electrically connecting said second heating grid to said first conductive segment and further including a second slide connector disposed between said second heating grid and said second conductive segment for electrically connecting said second heating grid to said second conductive segment with said first and second slide connectors spaced from each other.

16. A sliding window assembly as set forth in claim 15 further including a first terminal connector coupled to said first heating grid and spaced from said first connector and further including a second terminal connector coupled to said third heating grid and spaced from said second connector.

17. A sliding window assembly as set forth in claim 12 wherein said second connector comprises foam.

18. A sliding window assembly as set forth in claim 17 wherein said second connector further comprises a foil layer surrounding said foam to define a second conductive connector.

19. A sliding window assembly as set forth in claim 18 wherein said foil layer has a first surface and a second surface opposing said first surface and said second connector further comprises an adhesive layer abutting at least one of said first and second surfaces of said foil layer and at least one of said second conductive segment and said third heating grid for coupling said second conductive connector thereon.

20. A sliding window assembly as set forth in claim 11 wherein said track is further defined as a first track coupled to said first and second fixed panels and further including a second track coupled to said first and second fixed panels above said first track and said sliding panel movably coupled to said first and second tracks with said conductive rail coupled to one of said first and second tracks.

21. A sliding window assembly as set forth in claim 1 further including a first slide connector disposed between said second heating grid and said first conductive segment for electrically connecting said second heating grid to said first conductive segment and further including a second slide connector disposed between said second heating grid and said second conductive segment for electrically connecting said second heating grid to said second conductive segment with said first and second slide connectors spaced from each other.

22. A sliding window assembly as set forth in claim 21 wherein said first and second slide connectors are coupled to said sliding panel and movable with said sliding panel between said open and closed positions and wherein said first and second slide connectors each include a biasing member continuously engaging said first and second conductive segments respectively during movement of said sliding panel.

23. A sliding window assembly as set forth in claim 22 wherein said first and second conductive segments each define a channel cooperating with each other for receiving said sliding panel with said channel of said first and second conductive segments each have an inner surface receiving said sliding panel and an outer surface opposing said inner surface of respective segments with said biasing member of said first slide connector engaging said inner surface of said first conductive segment and said biasing member of said second slide connector engaging said inner surface of said second conductive segment.

24. A sliding window assembly as set forth in claim 1 wherein said insulator segment includes a base, a first side extending from said base, and a second side spaced from said first side and extending from said base to define a channel therebetween for receiving said sliding panel.

25. A sliding window assembly as set forth in claim 24 wherein said first side includes a first shoulder extending toward said second side and said second side includes a second shoulder extending toward said first side with said first and second shoulders spaced from each other.

26. A sliding window assembly as set forth in claim 25 wherein said first side includes a first flange disposed between said base and said first shoulder and extending outwardly away from said channel of said insulator segment for receiving said first conductive segment.

27. A sliding window assembly as set forth in claim 26 wherein said second side includes a second flange disposed between said base and said second shoulder and extending outwardly away from said channel of said insulator segment adjacent said first flange for receiving said first conductive segment.

28. A sliding window assembly as set forth in claim 27 wherein said first conductive segment includes a bottom, a first wall extending from said bottom, and a second wall spaced from said first wall and extending from said bottom to define a channel therebetween for receiving said sliding panel with said first wall including a first projection extending toward said second wall and said second wall including a second projection extending toward said first wall with said first and second flanges disposed in said channel of said first conductive segment between said bottom and said first and second projections respectively of said first conductive segment.

29. A sliding window assembly as set forth in claim 25 wherein said first side includes a third flange disposed between said base and said first shoulder and extending outwardly away from said channel of said insulator segment for receiving said second conductive segment.

30. A sliding window assembly as set forth in claim 29 wherein said second side includes a fourth flange disposed between said base and said second shoulder and extending outwardly away from said channel of said insulator segment adjacent said third flange for receiving said second conductive segment.

31. A sliding window assembly as set forth in claim 30 wherein said second conductive segment includes a bottom, a first wall extending from said bottom, and a second wall spaced from said first wall and extending from said bottom to define a channel therebetween for receiving said sliding panel with said first wall including a first projection extending toward said second wall and said second wall including a second projection extending toward said first wall with said third and fourth flanges disposed in said channel of said second conductive segment between said bottom and said first and second projections respectively of said second conductive segment.

32. A sliding window assembly as set forth in claim 25 wherein said first side includes a lip spaced from said first shoulder and said base to define a recess adjacent said channel of said insulator segment.

33. A sliding window assembly as set forth in claim 1 wherein said insulator segment includes a first face and a second face spaced from each other with said first conductive segment abutting said first face and said second conductive segment abutting said second face for spacing apart said first and second conductive segments.

34. A sliding window assembly as set forth in claim 1 wherein said track is further defined as a first track and further including a second track coupled to said fixed panel above said first track and said sliding panel movably coupled to said first and second tracks with said conductive rail coupled to one of said first and second tracks.

35. A sliding window assembly as set forth in claim 34 wherein said conductive rail is coupled to said first track.

36. A sliding window assembly as set forth in claim 34 wherein said conductive rail is coupled to said second track.

37. A sliding window assembly as set forth in claim 34 further including a rail spaced from said conductive rail and said sliding panel movably coupled to said rail with said conductive rail coupled to said first track and said rail coupled to said second track.

38. A sliding window assembly as set forth in claim 34 further including a rail spaced from said conductive rail and said sliding panel movably coupled to said rail with said rail coupled to said first track and said conductive rail coupled to said second track.

39. A sliding window assembly for a vehicle, said assembly comprising:
a panel adapted to be coupled to the vehicle;
a heating grid coupled to said panel for defrosting said panel;
a conductive rail coupled to said panel for electrifying said heating grid; and
a connector disposed between said heating grid and said conductive rail with said connector comprising a compressible material and having a conductive property to define a conductive connector for electrically connecting said heating grid to said conductive rail.

40. A sliding window assembly as set forth in claim 39 wherein said connector has a compression-deflection of less than 12 psi, at 25% deflection, according to ASTM D3574 Modified; and/or a compression set of less than 20%, at 25% deflection, according to ASTM D395 Method B.

41. A sliding window assembly as set forth in claim 39 wherein said connector defines a first thickness prior to being compressed between said heating grid and said conductive rail and a second thickness of about ½ to ⅔ less than said first thickness after being compressed between said heating grid and said conductive rail.

42. A sliding window assembly as set forth in claim 39 wherein said compressible material comprises a foam.

43. A sliding window assembly as set forth in claim 42 wherein said foam comprises a polymer.

44. A sliding window assembly as set forth in claim 43 wherein said polymer is polyurethane.

45. A sliding window assembly as set forth in claim 43 wherein said polymer is rubber and is formed from ethylene propylene diene monomer (EPDM).

46. A sliding window assembly as set forth in claim 39 wherein said connector further comprises a conductive filler dispersed in said compressible material for electrically connecting said heating grid to said conductive rail.

47. A sliding window assembly as set forth in claim 46 wherein said conductive filler comprises metal.

48. A sliding window assembly as set forth in claim 42 wherein said connector further comprises a foil layer surrounding said foam.

49. A sliding window assembly as set forth in claim 48 wherein said foil layer comprise aluminum.

50. A sliding window assembly as set forth in claim 48 wherein said foam has an outer periphery and said foil layer entirely surrounds said outer periphery.

51. A sliding window assembly as set forth in claim 48 wherein said foil layer has a first surface and a second surface opposing said first surface and said connector further comprises an adhesive layer abutting at least one of said first and second surfaces of said foil layer and at least one of said heating grid and said conductive rail for coupling said conductive connector thereon.

52. A sliding window assembly as set forth in claim 39 further comprising an adhesive layer abutting at least one of said heating grid and said conductive rail for coupling said conductive connector thereon.

53. A sliding window assembly as set forth in claim 52 wherein said adhesive layer is formed from a conductive composition.
